(19) United States
(12) Patent Application Publication
(10) Pub. No.: US 2023/0101550 A1
(43) Pub. Date: Mar. 30, 2023

(54) ENERGY STORAGE SYSTEMS AND METHODS FOR MANAGING INCREASED PEAK DEMAND

(71) Applicant: SPARKION POWER ALGORITHMS LTD, Herzliya (IL)

(72) Inventor: Tomer BENTZION, Tel Aviv (IL)

(21) Appl. No.: 17/910,134

(22) PCT Filed: Mar. 8, 2021
(86) PCT No.: PCT/IL2021/050255

§ 371 Date: Sep. 8, 2022

Related U.S. Application Data
(60) Provisional application No. 62/986,865, filed on Mar. 9, 2020.

(51) Int. Cl. B60L 53/64; B60L 53/53; B60L 53/66; H02J 3/32; H01M 10/44

(52) U.S. Cl. CPC B60L 53/64; B60L 53/53; B60L 53/665; H02J 3/322; H01M 10/441; H02J 2310/48

(57) ABSTRACT

Disclosed herein is a system a including a controller, a switching assembly commanded by the controller, and a DC-DC charger associated via the switching assembly with an array of power storage devices (PSDs). The system is controllably connectable to a power source, and, to rechargeable loads. The switching assembly is configured to individually enable and circumvent PSDs in the array. The controller is communicatively associated with a computational module configured to receive charging requirements of a rechargeable load, and, based thereon, select whether to charge the load exclusively via PSDs in the array, exclusively via the power source, or jointly thereby, so as to substantially minimize power consumption, charging time, and/or electricity cost, and/or achieve a desired trade-off there between. The controller is configured to receive the selection from the computational module, and, if required, command the switching assembly to enable charging of the load by the selected PSDs.

### TECHNICAL FIELD

The present disclosure relates generally to energy storage systems.

### BACKGROUND

The International Energy Agency has estimated that by 2030 there will be more than 250 million electric vehicles (EVs) worldwide. Power grids are not designed to meet peak demand for EV charging. For example, the power consumption of two EVs charging at 100 kW is equal to the average power consumption of about 100 US households. Upgrading existent power grids to meet future peak demand entails huge costs. Further, “last mile” energy supply far from bereft of infrastructure challenges. Consequently, there exists unmet need in the art for energy storage solutions, which would allow to effectively flatten peak demand, and in addition, are energy as well as cost efficient.

### SUMMARY

Aspects of the disclosure, according to some embodiments thereof, relate to energy storage systems and methods. More specifically, but not exclusively, aspects of the disclosure, according to some embodiments thereof, relate to systems and methods for managing rechargeable energy storage, which services rechargeable loads.

The present disclosure describes a system for managing an array of rechargeable power storage devices (PSDs), which is used to service one or more rechargeable loads. According to some embodiments, the system includes a plurality switching modules, each of which is installable on a respective PSD in the array. Each “switch-equipped” PSD may be individually enabled and circumvented, irrespectively, on the operational status of other PSDs in the array.

The above-specified capacity (i.e. to individually address PSDs) may advantageously be utilized by the system in at least three complementary ways to in order reduce overall power consumption and overall electricity costs, and/or, if required, charging times:
i. Optimized charging—In response to a charge request from a rechargeable load, select whether to at least partially charge the load from a power source (e.g. an electrical grid) and/or select one or more PSDs in the array to charge the load, so as to substantially minimize one or more of a power consumption, charging time, and electricity cost, and/or achieve a desired trade-off therebetween, optionally, taking into account an expected (future) power demand and/or future electricity costs.
ii. Real-time adjustments—Monitoring the status of the PSDs used to charge the rechargeable load, during the charging thereof, and, if necessary, reconfiguring the array (e.g. by enabling/circumventing one or more PSDs in the array), such that charging remains substantially optimum throughout. For example, if one of a plurality of serially-connected PSDs in the array—which are employed to charge the load—unexpectedly starts underperforming, that PSD may be circumvented, and, optionally, another DSP may be enabled instead.
iii. Advance planning to meet an expected power demand—A timetable may be determined, based on the expected power demand, such that electricity costs are kept low and, at the same time, a ready supply of power is maintained stored in the array, so as to meet the expected power demand. The timetable specifies when each of the PSDs is to be utilized, and, in particular, when each of the PSDs is to be charged.

Thus, according to an aspect of some embodiments, there is provided a system for managing a rechargeable energy storage. The system includes a controller, a switching assembly commanded by the controller, and a DC-DC charger associated or associable via the switching assembly with an array including a plurality power storage devices (PSDs). The system is configured to be connected to a power source, and to be connected to rechargeable loads of different charging voltages at least via the DC-DC charger. The switching assembly is configured to individually (independently) enable and circumvent at least some of the PSDs in the array. The controller is communicatively associated with a computational module configured to:
receive charging requirements of a rechargeable load;
based at least on the charging requirements, select whether to charge the load (i) exclusively via one or more PSDs in the array, (ii) exclusively via the power source, or (iii) jointly via one or more PSDs in the array and the power source, the selection being configured so as to substantially minimize one or more of a power consumption, charging time, and electricity cost, and/or achieve a desired trade-off there between; and
send the selection to the controller.

The controller is configured to, on receipt of the selection, if required, command the switching assembly to enable charging of the load by the selected PSDs.

According to some embodiments, the computational module includes a processing module and a memory module. The memory module may have stored therein software—a executable by the processing module—which causes the processing module to make the selection (of the PSDs), based at least on the charging requirements.

According to some embodiments, the system further includes the memory module.

According to some embodiments, the system further includes the computational module.

According to some embodiments, the plurality of PSDs includes at least three connected or connectable PSDs.

According to some embodiments, the plurality of PSDs includes at least four connected or connectable PSDs.

According to some embodiments, the plurality of PSDs includes at least five connected or connectable PSDs.

According to some embodiments, the charging requirements include values of one or more of a charging voltage, a charging current, and a charging power of the load.

According to some embodiments, the computational module is configured to make the selection, such that at least one of voltage, current, and power supplied to the load would remain substantially continuous (e.g. drop by 20% at most, 10% at most, or 5% at most, each possibility corresponds to different embodiments) under disabling of:
any PSD, included in the selection, which is configured to allow independent circumvention thereof (thereby disabling the PSD); and
any group of PSDs, included in the selection, which consists of selected PSDs that cannot be independently circumvented, but such that the group is configured to allow independent circumvention and/or disconnection thereof (thereby disabling the group).

According to some embodiments, the computational module is configured to make the selection, such that power supplied to the load would remain substantially continuous (e.g. drop by 20% at most, 10% at most, or 5% at most, each possibility corresponds to different embodiments) under disabling of:
any PSD, included in the selection, which is configured to allow independent circumvention thereof; and
any group of PSDs, included in the selection, which consists of selected PSDs that cannot be independently circumvented, but such that the group is configured to allow independent circumvention and/or disconnection thereof.

According to some embodiments, at least some of the selected PSDs are serially connected or connectable to one another.

According to some embodiments, the switching assembly is configured to allow, during charging of a load, increasing a number of PSDs used to charge a load, as well as replacing one or more of the selected PSDs by one or more other PSDs.

According to some embodiments, the system further includes monitoring equipment. The monitoring equipment is configured to monitor the PSDs in the array, or at least charging or discharging PSDs in the array, and send monitored values thereof to the controller and/or the computational module.

According to some embodiments, the monitoring equipment includes one or more of an ammeter, a voltmeter, an ohmmeter, a capacitance meter, a thermometer, and a pressure meter.

According to some embodiments, the monitoring equipment is further configured to monitor each charging load and send monitored values thereof to the controller and/or the computational module.

According to some embodiments, during discharging of a PSD in the array, the computational module and/or the controller are configured to, when the discharging PSD is depleted or sufficiently near depleted, over-heated, and/or over-pressurized, instruct the switching assembly to circumvent the PSD.

According to some embodiments, during charging of a PSD in the array, the computational module and/or the controller are configured to, when the charging PSD is saturated or sufficiently near saturated, over-heated, and/or over-pressurized, instruct the switching assembly to circumvent the PSD.

According to some embodiments, during charging of a load, the computational module and/or the controller are configured to, when the load is saturated or sufficiently near saturated, instruct the switching assembly to disconnect the load.

According to some embodiments, the array is a two-dimensional or three-dimensional rectangular array.

According to some embodiments, wherein the system further includes the monitoring equipment, the computational module and/or the controller are configured to, based on real-time data from the monitoring equipment: (i) determine status of PSDs in the array, (ii) based on the status, decide if one or more of the PSDs in the array are to be enabled and/or circumvented (or otherwise disabled), such as to continue substantially minimizing the one or more of the power consumption, charging time, electricity cost, and/or achieve the desired trade-off there between, and, if so, (iii) command the switching assembly to enable and/or circumvent (or otherwise disable) said one or more PSDs.

According to some embodiments, the switching assembly is configured to allow rewiring the array, so as to redefine groups of serially connected PSDs in the array.

According to some embodiments, wherein the system further includes the monitoring equipment, the computational module and/or the controller are configured to, based on real-time data from the monitoring equipment: (i) determine status of PSDs in the array, (ii) based on the status, decide if the array is to be rewired, such as to continue substantially minimizing the one or more of the power consumption, charging time, electricity cost, and/or achieve the desired trade-off there between, and, if so, (iii) command the switching assembly to rewire the array as decided.

According to some embodiments, the computational module is further configured to: (i) determine a timetable for utilizing PSDs in the array, taking into account an expected power demand, so as to keep electricity costs low and ensure a ready supply of power to meet the expected power demand, and (ii) send the timetable to the controller. The controller is configured to command the switching assembly to enable and/or circumvent (or otherwise disable) PSDs in the array in accordance with the timetable.

According to some embodiments, the utilizing of PSDs in the array includes charging depleted and/or non-saturated PSDs in the array.

According to some embodiments, the computational module is further configured to determine the expected power demand, based at least on scheduled charging requests.

According to some embodiments, in response to an unscheduled charging request, the computational module is configured to check whether the timetable has to be adjusted in order to keep the electricity costs low and ensure the ready supply of power to meet the expected power demand, and, if so, accordingly update the timetable.

According to some embodiments, the computational module is further configured to determine the expected power demand taking into account, or additionally taking into account, usage patterns of the system or a plurality of the system.

According to some embodiments, wherein the computational module includes the processing module and the memory module, the software stored in the memory module includes one or more machine-learning algorithms and/or algorithms derivable (capable of being generated) using machine-learning tools. The machine learning tools are configured to identify the usage patterns by analyzing past usage data of the system or the plurality of the system. The one or more machine-learning algorithms derivable using machine-learning tools and/or algorithms are configured to determine the expected power demand based on the usage patterns.

According to some embodiments, the switching assembly is configured to allow charging one or more PSDs in the array while one or more other PSDs in the array are discharging.

According to some embodiments, the rechargeable load may be an electric vehicle (EV) battery pack or battery module.

According to some embodiments, the rechargeable load may be a battery pack or battery module of electric mobile industrial machinery.

According to some embodiments, the DC-DC charger is bi-directional.

According to some embodiments, the system further includes one or more additional DC-DC chargers, so as to allow simultaneously charging a plurality of rechargeable loads characterized by different charging voltages.

According to some embodiments, the system is further configured to allow selectively discharging loads into one or more PSDs in the array and/or into the power source.

According to some embodiments, further comprising one or more DC-AC chargers, being thereby configured to power AC loads.

According to some embodiments, the switching assembly is configured to allow selectively discharging PSDs in the array into the power source.

According to some embodiments, the array is modular so as to allow adding one or more additional PSDs to the array.

According to some embodiments, the switching assembly is configured to allow replacing one or more PSDs in the array while one or more other PSDs in the array are charging and/or discharging.

According to some embodiments, the power source may be an electrical grid.

According to some embodiments, the power source may be off-grid.

According to some embodiments, the power source may be a renewable energy plant or farm.

According to some embodiments, the PSDs in the array include a plurality of battery packs and/or battery modules of EVs.

According to some embodiments, the plurality of battery packs and/or battery modules of EVs include battery packs and/or battery modules of electric cars, vans, trucks, and/or motorcycles.

According to some embodiments, the battery packs and/or the battery modules are second-life battery packs and/or second-life battery modules, respectively.

According to some embodiments, the computational module is cloud-based and the system further includes a communication unit configured to communicatively associate the controller with the computational module.

According to some embodiments, the computational module is a computer server.

According to some embodiments, the system further includes the PSD array.

According to an aspect of some embodiments, there is provided a computer-implemented method for managing responses of an energy storage to charge requests of one or more rechargeable loads. The energy storage includes a plurality of rechargeable power-storage devices (PSDs), and is connectable to a power source. The method includes:
receiving charging requirements of a rechargeable load that is to be charged;
based on the charging requirements, selecting whether to charge the load (i) exclusively via one or more PSDs from the plurality of PSDs, (ii) exclusively via the power source, or (iii) jointly via one or more PSDs, from the plurality of PSDs, and the power source, so as to substantially minimize one or more of a power consumption, charging time, and electricity cost, and/or achieve a desired trade-off there between; and
charging the load according to the selection.

According to some embodiments, the charging requirements includes values of one or more of a charging voltage, a charging current, and a charging power of the load.

According to some embodiments, the plurality of PSDs includes at least three connected or connectable PSDs.

According to some embodiments, the plurality of PSDs includes at least four connected or connectable PSDs.

According to some embodiments, the plurality of PSDs includes at least five connected or connectable PSDs.

According to some embodiments, in the operation of selecting, the selection is made such that at least one of voltage, current, and power supplied to the load would remain substantially continuous (e.g. drop by 20% at most, 10% at most, or 5% at most, each possibility corresponds to different embodiments) under disabling of:
any PSD, included in the selection, which is configured to allow independent circumvention thereof; and
any group of PSDs, included in the selection, which consists of selected PSDs that cannot be independently disabled, but such that the group is configured to allow independent circumvention and/or disconnection thereof.

According to some embodiments, in the operation of selecting, the selection is made such that power supplied to the load would remain substantially continuous (e.g. drop by 20% at most, 10% at most, or 5% at most, each possibility corresponds to different embodiments) under disabling of:
any PSD, included in the selection, which is configured to allow independent circumvention thereof; and
any group of PSDs, included in the selection, which consists of selected PSDs that cannot be independently disabled, but such that the group is configured to allow independent circumvention and/or disconnection thereof.

According to some embodiments, the selected PSDs include two or more groups of PSDs, such that, in the operation of charging, the groups are sequentially utilized to charge the load.

According to some embodiments, the selected PSDs include two or more serially connected or connectable PSDs.

According to some embodiments, the plurality of PSDs is arranged in a two-dimensional or three-dimensional rectangular array.

According to some embodiments, the method further includes monitoring one or more electrical parameters of discharging PSDs, and, when a monitored value of an electrical parameter of a discharging PSD indicates that the discharging PSD is depleted or sufficiently near depleted, circumventing the discharging PSD.

According to some embodiments, the method further includes charging of PSDs, which have been circumvented due to being depleted or sufficiently near depleted.

According to some embodiments, the method further includes monitoring one or more electrical parameters of charging PSDs, and, when a monitored value of an electrical parameter of a charging PSD indicates that the charging PSD is saturated or sufficiently near saturated, circumventing the charging PSD.

According to some embodiments, the method further includes:
monitoring charging and/or discharging PSDs to obtain one or more safety-related parameters of the charging and/or discharging PSDs; and
when a monitored value of one of the one or more safety-related parameters of a PSD from the charging PSDs, or the discharging PSDs, crosses a respective threshold, circumventing the PSD.

The one or more safety-related parameters include one or more of maximum currents, maximum powers, minimum voltages, maximum voltages, maximum temperatures and/or maximum internal pressures allowable for the charging and/or discharging PSDs.

According to some embodiments, the one or more electrical parameters include one or more of a state-of-charge (SoC) of a PSD, remaining capacity in the PSD, voltage across the PSD, resistance of the PSD, capacitance of the PSD, and charge rate or discharge rate of the PSD.

According to some embodiments, further includes, based on real-time monitored data of PSDs from the selected PSDs:
determining status of the PSDs;
based on the status, deciding if one or more of the PSDs are to be enabled and/or circumvented (or otherwise disabled), such as to continue substantially minimizing the one or more of the power consumption, charging time, electricity cost, and/or maintain the desired trade-off there between; and
if so, enabling and/or disabling (or otherwise disabling) the one or more of the PSDs.

According to some embodiments, the method further includes, based on real-time monitored data of the PSDs from the selected PSDs:
determining status of the PSDs;
based on the status, deciding if the plurality of PSDs is to be rewired, such as to continue substantially minimizing the one or more of the power consumption, charging time, electricity cost, and/or maintain the desired trade-off there between; and
if so, accordingly rewiring the plurality of PSDs.

According to some embodiments, the method further includes monitoring one or more electrical parameters of a load being charged by the energy storage, and when a monitored value of an electrical parameter of the charging load indicates that the charging load is saturated or sufficiently near saturated, disconnecting the charging load.

According to some embodiments, the one or more electrical parameters of the charging load include one or more of a SoC of the charging load, remaining capacity in the charging load, voltage across the charging load, resistance of the charging load, capacitance of the charging load, and charge rate of the charging load.

According to some embodiments, the method further includes:
monitoring the charging load to obtain one or more safety-related parameters thereof; and
when a monitored value of one of the one or more safety-related parameters of the charging load crosses a respective threshold, disconnecting the charging load.

The one or more safety-related parameters include one or more of a maximum current, maximum power, minimum voltage, and maximum voltage allowable for the charging load.

According to some embodiments, in the operation of selecting, a timetable for employing PSDs, from the plurality of PSDs, is additionally taken into account. The timetable is configured to, based on an expected power demand, to substantially minimize an average electricity cost and/or an average power consumption, and/or ensure a ready supply of power to meet the expected power demand.

According to some embodiments, the method further includes determining the timetable and utilizing PSDs from the plurality of PSDs according to the timetable.

According to some embodiments, the method further includes determining the expected power demand, based at least on scheduled charging requests.

According to some embodiments, the method further includes in response to an unscheduled charging request:
checking if the timetable has to be updated in order to maintain the average electricity cost and average power consumption substantially minimum, and/or continue ensuring a ready supply of power to meet the expected power demand; and
if so, accordingly updating the timetable.

According to some embodiments, the method further includes determining the expected power demand, taking into account usage patterns of the energy storage or a plurality of the energy storage.

According to some embodiments, the method further includes identifying the usage patterns by analyzing past usage data of the energy storage or a plurality of the energy storage.

According to some embodiments, machine-learning tools are employed to identify the usage patterns.

According to some embodiments, the expected power demand is determined utilizing one or more machine-learning algorithms and/or machine-learning derivable algorithms.

According to some embodiments, the timetable is further configured to substantially minimize or at least reduce a retirement rate of PSDs from the plurality of PSDs.

According to some embodiments, the rechargeable load is an electric vehicle (EV) battery pack or module.

According to some embodiments, the rechargeable load is a battery pack or battery module of electric mobile industrial machinery.

According to some embodiments, the power source is an electrical grid.

According to some embodiments, the power source is off-grid.

According to some embodiments, the power source is a renewable energy plant or farm.

According to some embodiments, the plurality of PSDs includes a plurality of battery packs and/or battery modules of EVs.

According to some embodiments, the plurality of battery packs and/or battery modules of EVs include battery packs and/or battery modules of electric cars, vans, trucks, and/or motorcycles.

According to some embodiments, the battery packs and/or the battery modules are second-life battery packs and/or second-life battery modules, respectively.

According to an aspect of some embodiments, there is provided a non-transitory computer-readable storage medium. The storage medium stores instructions that cause a processing module associated with a controller of an energy storage (such as the above-described energy storage), and/or cause the controller of the energy storage, to implement the above-described method for managing responses of an energy storage to charge requests of one or more rechargeable loads. The energy storage includes a plurality of rechargeable power storage devices.

According to an aspect of some embodiments, there is provided a computer-implemented method for managing an energy storage for servicing one or more rechargeable loads. The energy storage includes a plurality of rechargeable power-storage devices (PSDs), and is connectable to a power source. The method includes:
planning (i.e. determining) a timetable for employing PSDs from the plurality of PSDs, taking into account an expected power demand, so as to substantially minimize an average electricity cost and/or average power consumption, and/or ensure a ready supply of power to meet the expected power demand; and
utilizing the PSDs from the plurality of PSDs according to the timetable.

According to some embodiments, the employing of the PSDs includes charging and discharging PSDs.

According to some embodiments, the method further includes determining the expected power demand, based at least on scheduled charging requests.

According to some embodiments, the method further includes in response to an unscheduled charging request:
checking if the timetable has to be updated in order to maintain the average electricity cost and average power consumption substantially minimum, and/or continue ensuring a ready supply of power to meet the expected power demand; and
if so, accordingly updating the timetable.

According to some embodiments, the method further includes determining the expected power demand, taking into account usage patterns of the energy storage or a plurality of the energy storage.

According to some embodiments, the method further includes identifying the usage patterns by analyzing past usage data of the energy storage or a plurality of the energy storage.

According to some embodiments, machine-learning tools are employed to identify the usage patterns.

According to some embodiments, the expected power demand is determined utilizing one or more machine-learning algorithms and/or machine-learning derivable algorithms.

According to some embodiments, the timetable is further configured to substantially minimize or at least reduce a retirement rate of PSDs from the plurality of PSDs.

According to some embodiments, the rechargeable load may be an electric vehicle (EV) battery pack or module.

According to some embodiments, the rechargeable load may be a battery pack or battery module of electric mobile industrial machinery.

According to some embodiments, the power source may be an electrical grid.

According to some embodiments, the power source may be off-grid.

According to some embodiments, the power source may be a renewable energy plant or farm.

According to some embodiments, the plurality of PSDs includes a plurality of battery packs and/or battery modules of EVs.

According to some embodiments, the plurality of battery packs and/or battery modules of EVs include battery packs and/or battery modules of electric cars, vans, trucks, and/or motorcycles.

According to some embodiments, the battery packs and/or the battery modules are second-life battery packs and/or second-life battery modules, respectively.

According to an aspect of some embodiments, there is provided a non-transitory computer-readable storage medium. The storage medium stores instructions that cause a processing module associated with a controller of an energy storage (such as the above-described energy storage), and/or cause the controller of the energy storage, to implement the above-described method for managing an energy storage for servicing one or more rechargeable loads. The energy storage includes a plurality of rechargeable power storage devices.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

Unless specifically stated otherwise, as apparent from the disclosure, it is appreciated that, according to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices.

Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In the figures:

FIG. 1 presents a block diagram of a system for managing power storage, supply, and distribution by an array of rechargeable power storage devices configured for servicing rechargeable loads, according to some embodiments;

FIG. 2A presents a circuit diagram relating DC-DC chargers, switching modules, and switches of the system of FIG. 1 to the power storage devices in the array of FIG. 1, according to some embodiments;

FIGS. 2B to 2J respectively illustrate example wiring configurations of the power storage devices of FIG. 2A, according to some embodiments;

FIG. 3 schematically depicts an electric vehicle charging station including a specific embodiment of the power management system of FIG. 1;

FIG. 4A schematically depicts an electric vehicle charging station including a specific embodiment of the power management system of FIG. 1;

FIG. 4B presents a schematic cutaway view of a charging unit of the electric vehicle charging station of FIG. 4B, according to some embodiments;

FIG. 5 is a flowchart of a computer-implemented method for managing responses of an energy storage to charge requests of one or more rechargeable loads, the energy storage includes a plurality of rechargeable power storage devices and is connectable to a power source, according to some embodiments; and

FIG. 6 is a flowchart of a computer-implemented method for managing an energy storage, which is configured for servicing rechargeable loads, includes a plurality of rechargeable power-storage devices (PSDs), and is connectable to a power source, according to some embodiments.

### DETAILED DESCRIPTION

The principles, uses, and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, the words “include” and “have”, and forms thereof, are not limited to members in a list with which the words may be associated.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “substantially” and “about” may be interchangeable.

As used herein, the term “substantially” may be used to specify that a first parameter (e.g. voltage, current, power) is about equal to a second or a target parameter. The case wherein the first parameter is equal to the target parameter is also encompassed by the statement that the first parameter is “substantially equal” to the target parameter. According to some embodiments, the target parameter may be optimal, in the sense of being in principle obtainable using mathematical optimization software.

As used herein, according to some embodiments, a value assumed by a parameter is “substantially equal” to the minimum possible value assumable by the parameter, when the value of the parameter is greater by at most 20% than the minimum possible value. In particular, the case wherein the value of the parameter is equal to the minimum possible value is also encompassed by the statement that the value assumed by the parameter is “substantially equal” to the minimum possible value assumable by the parameter. Similarly, according to some embodiments, a value assumed by a parameter is “substantially equal” to the maximum possible value assumable by the parameter, when the value of the parameter is smaller by at most 20% than the maximum possible value. In particular, the case wherein the value of the parameter is equal to the maximum possible value is also encompassed by the statement that the value assumed by the parameter is “substantially equal” to the maximum possible value assumable by the parameter.

As used herein, a change to a parameter (e.g. voltage, current, power) may be said to be “substantially continuous” when the value of the parameter changes by no more than 20% of its initial value.

As used herein, the verb “to circumvent” is used in the meaning of “to bypass”. Accordingly, the verbs “to circumvent” and “to bypass” are used interchangeably, as are derivatives thereof.

As used herein, the term “electric vehicle” (EV) is to be understood in an expansive manner and may refer to any electrically-powered vehicle, whether manned or autonomous, that includes one or more rechargeable battery modules or rechargeable battery packs. The term “electric vehicle” should also be understood to cover any hybrid vehicle whose battery may be charged by plugging it into an external power source (using an external charger or an on-board charger). In particular, the term “electric vehicle” should be understood to cover electric scooters, bikes, motorcycles, passenger cars, vans, buses, trucks, aircrafts (such as drones, as well as manned planes and choppers), boats, ships, marine vessels (such as tankers, freighters, and barges), and (electric) mobile industrial machinery (such as tractors and forklifts).

Systems

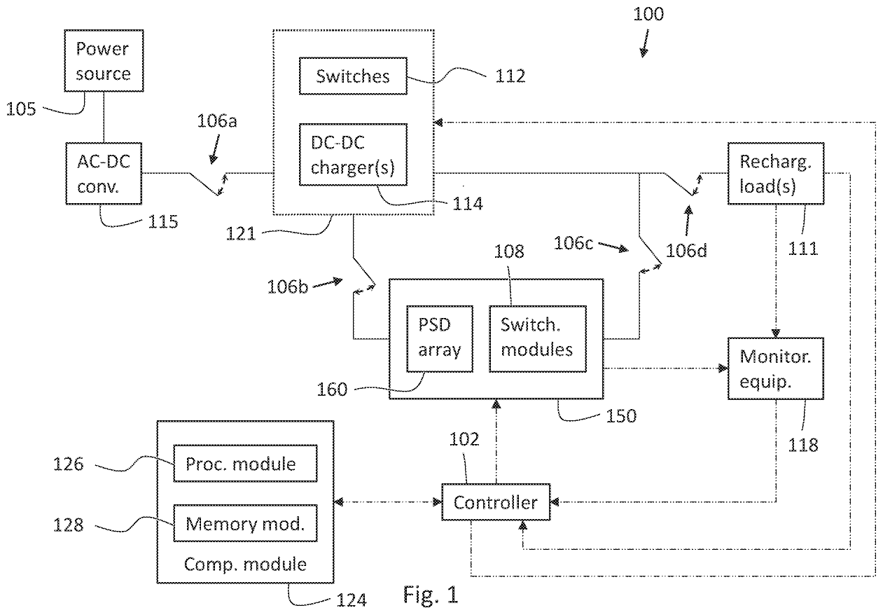

FIG. 1 presents a block diagram of a power management system (PMS) 100, according to some embodiments. PMS 100 may be configured to regulate storing, supply, and distribution of power by an energy storage, which includes an array of power storage devices (PSDs), such as a rechargeable energy storage 150, which includes a PSD array 160. Also depicted in FIG. 1 are an external power source 105, to which PMS 100 is controllably couplable (connectable), and one or more rechargeable loads 111, such as battery packs of electric vehicles (EVs). A dashed-double-dotted line, which connects two blocks (elements), indicates communication (i.e. flow of data) between the blocks. The communication may be one-way (or at least one-way), in which case a single arrowhead is included on the line, or two-way, in which case two arrowheads, pointing in opposite directions, are included on the line. A solid line, connecting two blocks, indicates possibility of (electrical) power (energy) transfer between blocks (i.e. possibility of flow of electrical current between the elements represented by the blocks). In particular, according to some embodiments, a solid line between blocks may represent a single electrical line (e.g. wire or cable) extending between the blocks or a plurality of electrical lines (e.g. wires and/or cables) extending between the blocks.

According to some embodiments, power source 105 may be a power grid (i.e. an electrical grid). According to some embodiments, power source 105 may be an (electrical) power plant. According to some such embodiments, power source 105 may be a renewable-energy power plant or farm, for example, a geothermal power plant, a solar farm, or a wind farm. According to some embodiments, power source 105 may be grid-tied or off-grid.

According to some embodiments, PMS 100 may be an EV charging station, e.g. a commercial EV charging station for servicing electric cars. According to some embodiments, PMS 100 may be deployed at an airfield or a port in order to service electric aircrafts or electric watercrafts, respectively. According to some embodiments, PMS 100 may be deployed at a construction site, a mining site, or even a farm, wherein EVs and/or electric mobile industrial machinery (e.g. a tractor, a forklift, a dumper) are used. According to some embodiments, PMS 100 may be deployed at a parking lot, for example, an underground parking of an office building and/or a residential building.

PMS 100 may include a controller 102 and a switching assembly including main switches 106, switching modules 108, and optionally, additional switches 112. According to some embodiments, PMS 100 may further include one or more DC-DC chargers 114. DC-DC chargers 114 are functionally associated with (i.e. connected to) switches 112, as elaborated on below.

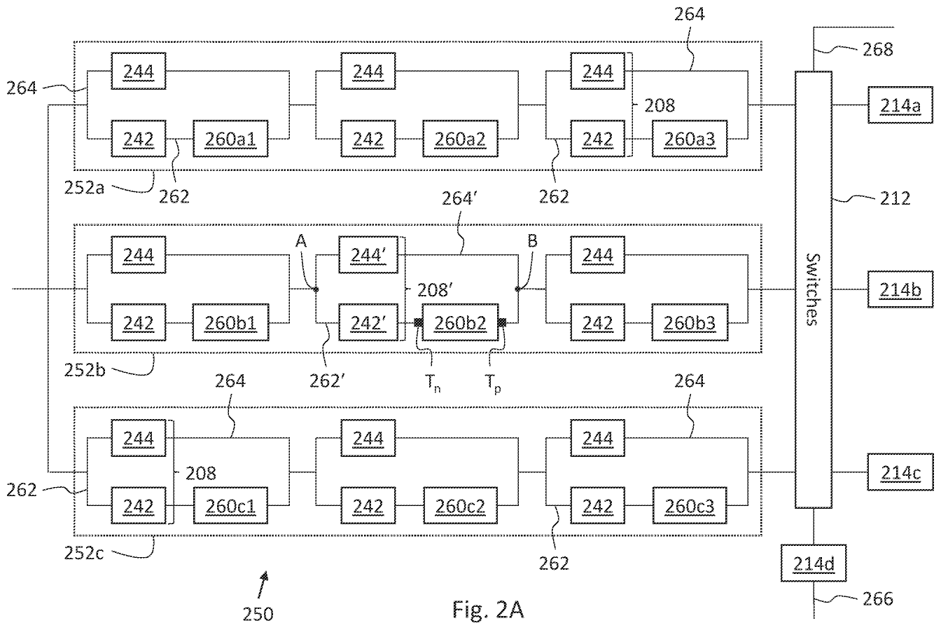

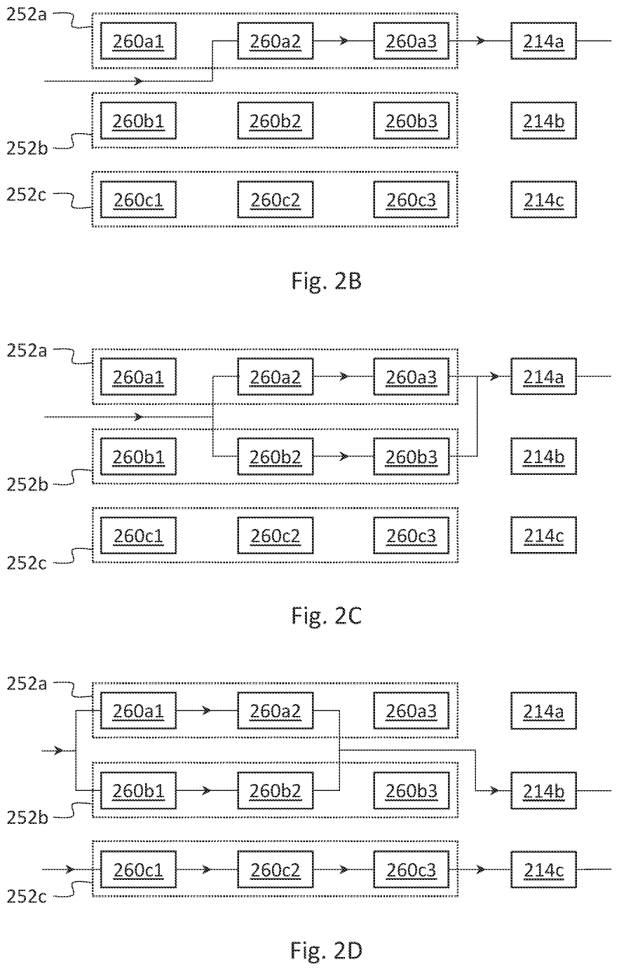

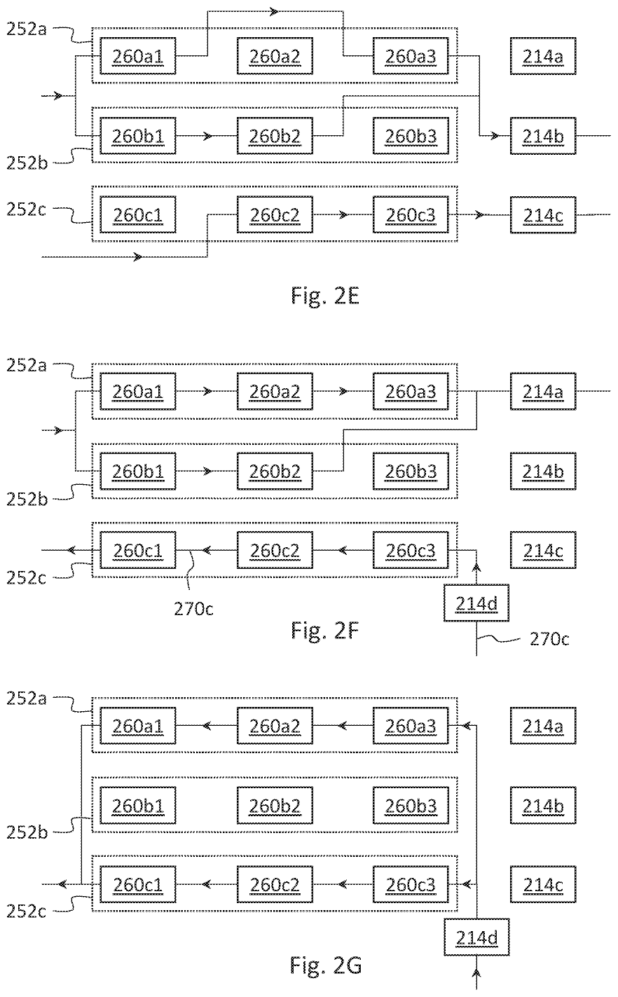

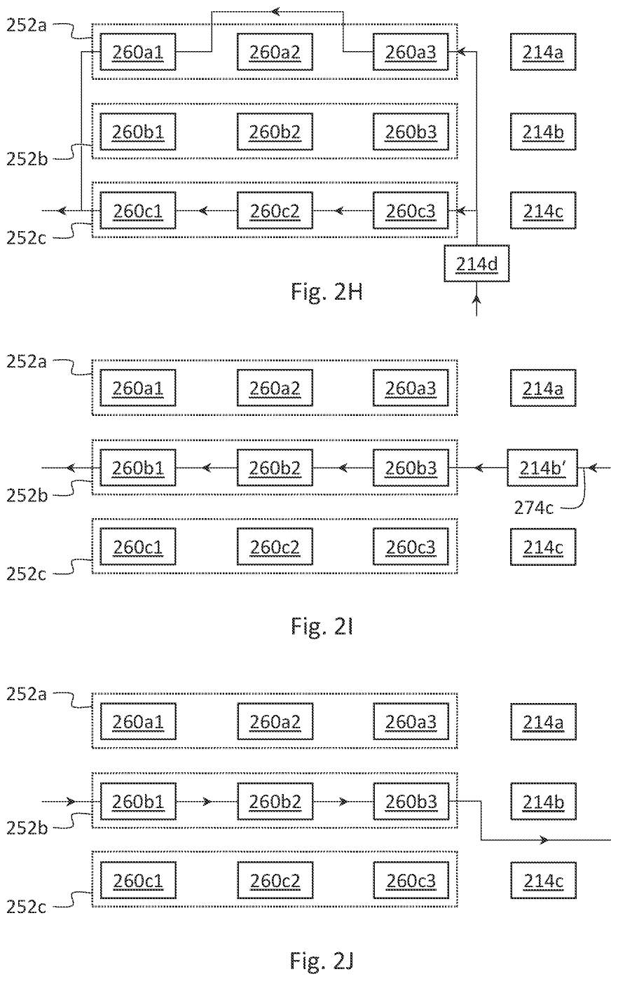

In order not to render FIG. 1 too cumbersome, the “aggregate” of switches 112 and DC-DC chargers 114 is shown within a dotted box 121. The connectivity between switches 112 and DC-DC chargers 114 is described below. Examples embodiments depicting connectivity between specific embodiments of switches 112 and DC-DC chargers 114 are presented in FIG. 2A.

According to some embodiments, and as depicted in FIG. 1, PMS 100 may further include monitoring equipment 118. According to some embodiments, controller 102 may be communicatively associable with a computational module 124. As elaborated on below, computational module may include a processing module 126 and a memory module 128. According to some embodiments, PMS 100 may include memory module 128. According to some embodiments, PMS 100 may further include processing module 126 (so that PMS 100 includes computational module 124). More generally, computational module 124 may include any combination of software, hardware, and/or firmware configured to enable the functionalities of computational module 124 described below.

According to some embodiments, as depicted in FIG. 1, wherein power source 105 provides an alternating current (AC)—for example, when power source 105 is a power grid—power source 105 may be electrically coupled to PMS 100 via an AC-DC converter 115. According to some embodiments, wherein power source 105 provides a direct current (DC)—for example, when power source 105 is a solar farm—power source 105 may be directly connected to PMS 100 (i.e. without an intermediate AC-DC converter).

To generalize the description, in the following it is assumed that one or more DC-DC chargers 114 include a plurality of DC-DC chargers, but it is to be understood that the scope of the disclosure also covers embodiments including a single DC-DC charger. Similarly, in the following it is assumed that one or more rechargeable loads 111 include a plurality of rechargeable loads, but it is to be understood that the scope of the disclosure also covers embodiments wherein PMS 100 is configured to service a single rechargeable load at a time.

According to some embodiments, at least one of DC-DC chargers 114 may be bi-directional.

PSD array 160 includes a plurality of PSDs. Each of the PSDs in PSD array 160 may be an electrochemical energy storage device, which is rechargeable. According to some embodiments, each of the PSDs in PSD array 160 may be an electrochemical cell (such as a lithium ion battery), a battery module, a battery pack, or a supercapacitor, as further detailed below.

Typically, an electrochemical cell includes an anode(s) and a cathode(s) with current collectors affixed thereto. The electrochemical cell includes a soft or hard package (e.g. a pouch, a prismatic or cylindrical package, and so on). As used herein, according to some embodiments, the terms “electrochemical cell” and “battery” may be used interchangeably. As used herein, a “battery module” may include a plurality of electrochemical cells. A “battery pack” may include one or more battery modules.

Rechargeable electrochemical energy storage devices, such as batteries and supercapacitors, come in a large variety of shapes and forms (cylindrical, prismatic, pouch, etc.) and types (chemistries). Examples of chemistries include lithium cobalt oxide (LiCoO₂), lithium iron phosphate (LFP), lithium manganese oxide (LMO), lithium nickel manganese cobalt oxide (NMC), lithium nickel cobalt aluminum oxide (NCA), and lithium titanate oxide (LTO). Other common rechargeable cell chemistries include lead acid, nickel-cadmium (NiCad), and nickel metal hydride (NiMH).

All of the above options (i.e. of shapes, forms, and chemistries) are covered by the scope of the disclosure. That is, each option represents separate embodiments of PSD 110. Further, disclosed PSD arrays, such as PSD array 160 or the PSD array depicted in FIG. 2A, are not limited to including a single type of PSDs. That is, different PSDs within the disclosed PSD arrays, according to some embodiments, may differ from one another in shape, form, and chemistry. Different combinations of the above options (e.g. an array including both LiCoO₂ batteries and NiCad batteries or an array including NMC batteries and NCA batteries) correspond to separate embodiments.

According to some embodiments, PSD array 160 may include repurposed battery modules or battery packs. That is, used battery modules or battery packs, which are no longer suitable for their original “roles”. According to some such embodiments, PSD array 160 may be or include second-life EV battery packs. That is, used EV battery packs, which are no longer employable as EV battery packs (e.g. due to reduced capacity and/or reduced charging rates).

According to some embodiments, different PSDs in PSD array 160 may differ from one another in output voltages, output currents, and/or capacities. For instance, some of the PSDs in PSD array 160 may be second-life battery packs of electric passenger cars while other of the PSDs in PSD array 160 may be second-life battery packs of electric buses and/or electric trucks. In particular, according to some embodiments, PSD array 160 may include PSDs differing from one another in chemistry and/or conditions, i.e. state-of-health (SoH). It is noted that even two PSDs manufactured to the same specification may significantly differ from one another in output voltages, output currents, and/or capacities (e.g. due to age or history of use).

The switching assembly is controlled or controllable by controller 102. That is, each of main switches 106, switching modules 108, and switches 112 are configured to be commanded by controller 102. PMS 100 may be connected to rechargeable loads 111, at least via DC-DC chargers 114, which, in turn, are controllably associable, via switches 112, with PSDs in PSD array 160, as described in detail below.

According to some embodiments, and as depicted in FIG. 1, main switches 106 include four main switches: a first main switch 106a, a second main switch 106b, a third main switch 106c, and a fourth main switch 106d. Main switches 106 are configured to couple between power source 105, PSD array 160, and loads 111, and decouple therebetween.

More specifically, according to some embodiments, in order to charge loads 111 exclusively from power source 105 (i.e. without employing any of the PSDs in PSD array 160), first main switch 106a and fourth main switch 106d are switched on (so that current may be conducted therethrough), while second main switch 106b and third main switch 106c are switched off (so that current is incapable of flowing therethrough). When PSD array 160 is used to charge loads 111—so that fourth main switch 106d is switched on—if second main switch 106b is switched on and third main switch 106c is switched off, the current from discharging PSDs in PSD array 160 will travel to loads 111, via DC-DC chargers 114. If instead, third main switch 106c is switched on and second main switch 106b is switched off, the current from the discharging PSDs travels directly (i.e. without passing through DC-DC chargers 114) to loads 111. If, in addition to second main switch 106b or third main switch 106c, first main switch 106a is (also) switched on, then loads 111 may be charged by both power source 105 and PSDs in PSD array 160.

According to some embodiments, in order to charge PSDs in PSD array 160 from power source 105, first main switch 106a and second main switch 106b may be switched on. If, in addition, fourth main switch 106d is switched on (and third main switch 106c is switched off), then power source 105 may not only charge PSDs in PSD array 160 but also charge loads 111. Additionally, or alternatively, according to some embodiments, with fourth main switch 106d being switched on (and third main switch 106c being switched off), switches 112 are configured to allow a first group of PSDs from PSD array 160 to be charged by power source 105, while a second group of other PSDs from PSD array 160 is employed to charge one or more of loads 111. The charging provided by the second group of PSDs may be in addition to the charging provided by power source 105 or instead of it. In particular, according to some embodiments, the second group of PSDs may charge a first subset (group) of loads from loads 111 and power source 105 may charge a second subset of loads from loads 111.

It is noted that in the above examples—wherein a load is charged by one or more of PSDs in PSD array 160—if no DC-DC conversion is necessary, then the load may be charged directly, with the respective charging current being conducted via (a switched on) third main switch 106c, rather than through second main switch 106b and DC-DC chargers 114.

According to some embodiments, PMS 100 may be configured to allow discharging of one or more of loads 111 onto PSD array 160 (i.e. charging of PSDs in PSD array 160 by one or more of loads 111). To implement the discharge, fourth main switch 106d is switched on. Assuming DC-DC conversion is necessary, second main switch 106b is switched on and third main switch 106c may be switched off. First main switch 106a may be switched on or off. For example, if power source 105 is simultaneously employed to charge one or more PSDs in PSD array 160 (optionally, the same PSDs charged by one or more of loads 111), then first main switch 106a is switched on.

According to some embodiments, PMS 100 may be configured to allow discharging of loads and/or PSDs in PSD array 160 onto power source 105.

According to some embodiments, each of switching modules 108 may be configured to enable/circumvent a respective PSD from PSD array 160. According to some embodiments, switches 112 may be configured to allow to selectively connect one or more groups of PSDs from PSD array 160 to a specific DC-DC charger from DC-DC chargers 114 or to power source 105. According to some embodiments, each group may constitute, for example, a row of (a rectangular array formed by) of PSDs from PSD array 160, so that each row may be individually (independently) enabled/disabled. According to some embodiments, and as depicted in FIG. 2A, each of the PSDs in the PSD array 160 may be individually addressable, with each of the switching modules being associated with a respective PSD from PSD array 160, so as to allow individually addressing the PSD (i.e. independently enabling/circumventing the PSD).

According to some embodiments, DC-DC chargers 114 may differ from one another in the respective ranges of the input voltages and output voltages thereof, thereby allowing to service, or more efficiently service, rechargeable loads characterized by different charging voltages.

According to some embodiments, PMS 100 may further include a DC-AC charger(s) (not shown) functionally associated with controller 102, and configured to allow powering an AC load. In particular, this allows for charging a battery pack, which has its AC-DC charger built-in so that it may only be connected to an AC current supply. With second main switch 106b, being switched on, the DC-AC charger may be selectively connected to one or more PSDs in PSD array 160, via switches 112. With fourth main switch 106d being switched on, the DC-AC charger may further be connected to an AC load(s) (so as to allow powering the AC load(s)). According to some embodiments, an AC load may be powered essentially directly from power source 105, particularly, when power source 105 is configured to provide an AC current. In such embodiments, PMS 100 may further include an AC-AC converter.

According to some embodiments, monitoring equipment 118 may include monitoring electronics (not shown), such as one or more ammeters, one or more voltmeters, one or more ohmmeters, one or more capacitance meters, and/or the like. According to some embodiments, monitoring equipment 118 may further include one or more thermometers and/or one or more pressure meters (not shown).

According to some embodiments, monitoring equipment 118 may be configured to monitor one or more electrical parameters, and optionally one or more physical parameters (e.g. in embodiments wherein monitoring equipment 118 further includes thermometers and/or pressure meters), of PSDs (e.g. individual PSDs) in PSD array 160. More precisely, from the monitored values—obtained by monitoring equipment 118 and sent to controller 102 and from there optionally relayed to computational module 124—values of one or more electrical parameters, and optionally one or more physical parameters, may be derived (unless measured directly by monitoring equipment 118). The electrical parameters may include one or more of a state-of-charge (SoC), a remaining capacity, a resistance, a capacitance, and a charge and/or discharge rate of one or more PSDs, one or more groups of PSDs, or even each PSD in PSD array 160. The physical parameters may include temperatures of PSDs in PSD array 160 (e.g. the temperatures within the PSDs) and internal pressures of PSDs in PSD array 160 (i.e. the pressures within the PSDs). Based on the monitored values, computational module 124 and/or controller 102 may elect to bypass (i.e. circumvent) a PSD, enable a PSD, and/or bypass (or otherwise disable) or enable a group of PSDs (e.g. a rows of PSD) in PSD array 160.

According to some embodiments, the sampling rate of monitored parameters of a PSD may depend on whether the PSD is in use, i.e. charging or discharging, with the sampling rate being significantly higher when the PSD is in use. According to some embodiments, at least some of the electrical parameters and/or physical parameters of a PSD may be monitored continuously, or effectively continuously.

According to some embodiments, monitoring equipment 118 may further be configured to monitor one or more electrical parameters, and optionally physical parameters, of each of loads 111, and send the monitored values to controller 102.

According to some embodiments, controller 102 may be configured to operate monitoring equipment 118 on demand, so as to allow running check-ups on PSDs or groups of PSDs, optionally, under different actuation configurations of the switching assembly and/or different wiring configurations of PSD array 160.

According to some embodiments, controller 102 is configured to receive at least values of a charging voltage, a charging current, and/or charging power of a rechargeable load (i.e. one of rechargeable loads 111), which is to be charged, and relay the received values to computational module 124. The received values may also include safety data of the load, such as a maximum temperature, a maximum charging current, and/or a maximum charging power allowed for the load. The received values may thus specify charging requirements of the load. According to some embodiments, the received values may additionally specify the SoC and (full) charge capacity of the load.

According to some embodiments, memory module 128 may have stored therein software—executable by processing module 126—configured to perform the computational tasks and decisions described herein below.

Computational module 124 is configured to select, based on the values received from controller 102, whether the load is to be charged using PSD array 160 and/or power source 105. That is, computational module 124 may opt to exclusively (i.e. solely) utilize PSDs in PSD array 160, exclusively utilize power source 105, or draw some of the power from PSD array 160 and some of the power from power source 105. More specifically, according to some embodiments, computational module 124 may further be configured to select which of the PSDs in PSD array 160 (e.g. which row or rows, which PSDs in the row or rows) is or are to be used to charge the load (i.e. when opting to charge the load using PSD array 160, whether exclusively or jointly with power source 105).

The selection may be such as to substantially minimize, one or more of a power consumption, charging time, electricity cost, and/or achieve a desired trade-off there between, as further elaborated on below. For example, during a time of the day when the price of electricity is high, computational module 124 may opt to charge a load using exclusively power source 105. However, the choice (i.e. the selection) may further be informed by a number and types of loads, which are scheduled to be charged, and/or expected require charging, later during the day (e.g. during peak demand when the price of electricity is maximum). If only a small number of loads are scheduled to be charged, and/or expected to require charging, before off-peak hours (when electricity is available at significantly lower rates)—such that exclusive utilization of PSD array 160 is not expected to result in depletion thereof in the intervening time period (i.e. until the off-peak hours)—during the intervening time period, computational module 124 may opt to charge loads utilizing exclusively PSD array 160. According to some embodiments, computational module 124 is configured to take into account at least some of the above-specified information, such that the total electricity cost is substantially kept to a minimum under the constraint that a pre-scheduled timetable is met, as further elaborated on below.

According to some embodiments, computational module 124 is configured to send the selection (i.e. whether to solely utilize power source 105, solely utilize PSD array 160, or utilize both PSD array 160, in the latter two cases the selection may additionally specify the PSDs (in PSD array 160) that are to be utilized) to controller 102. Controller 102 may be configured to, on receipt of the selection, command the switching assembly to (physically) implement the selection: that is, to switch on and/or off (if necessary) one or more of main switches 106, one or more switching modules from switching modules 108 that are associated with selected PSDs, and/or one or more switches from switches 112, so that the load is charged according to computational module 124 instructions (i.e. commands).

It is noted that the selection may be time-dependent in the sense some PSDs in PSD array 160 may be selected so as to be active (i.e. enabled to charge the load) during a first period time, while other PSDs in PSD array 160 may be selected so as to be active (i.e. enabled to charge the load) during a second period, which is distinct from the first period, and so on.

According to some embodiments, computational module 124 may be configured to circumvent (i.e. bypass) and enable PSDs, and/or enable or circumvent (or otherwise disable) groups of PSDs that are only jointly addressable, based on monitored parameters of PSDs in PSD array 160 and/or the charging load (received from monitoring equipment 118). More specifically, computational module 124 may be configured to, in response to receiving data (such as monitoring data received from monitoring equipment 118), which indicates that a discharging PSD is depleted or sufficiently near depleted, instruct the switching assembly to bypass the PSD. Similarly, computational module 124 may be configured to, in response to receiving data (from monitoring equipment 118), which indicates that a charging PSD is saturated or sufficiently near saturated, instruct the switching assembly to bypass the PSD. Further, computational module 124 may be configured to, in response to receiving data (from monitoring equipment 118), which indicates that a charging load is saturated or sufficiently near saturated, instruct the switching assembly to disconnect the load.

According to some embodiments, when the number of rechargeable loads that need to be charged within a prescribed period is such that PMS 100 cannot fully charge all the loads within the prescribed period, computational module 124 may be configured to instruct controller 102 to partially charge each load to a threshold (e.g. 80% of full capacity or 40 Ah), so as to ensure that by the end of the prescribed period each of the loads is at least charged to the threshold. Thus, for example, when a first of the loads reaches 80% of full capacity, that load is disconnected, when a second of the loads reaches 80% of full capacity, that load is disconnected, and so on. If the number of loads is greater than the maximum number of loads PMS 100 may simultaneously service, when a first of the loads reaches 80% of full capacity, that load is disconnected and charging of a next load in the queue is initiated, when a second of the loads reaches 80% of full capacity, that load is disconnected charging of a next load in the queue is initiated, and so on. According to some embodiments, the threshold may vary from one load to another. According to some embodiments, computational module 124 may prioritize the charging of the loads, such that some loads are charged earlier or faster than other loads.

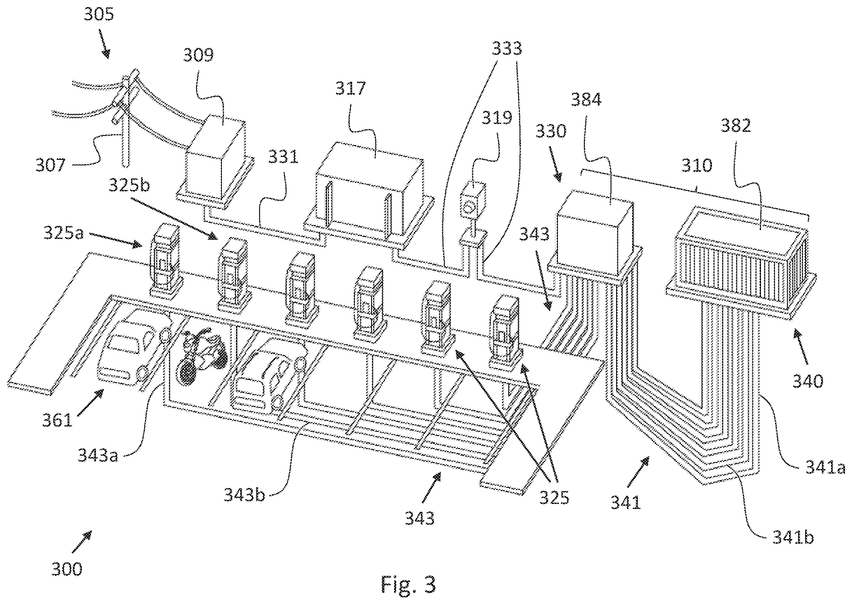

According to some embodiments, when the number of rechargeable loads that need to be charged within a short time (e.g. within a next hour) is greater than the maximum number that PMS 100 can simultaneously service—for example, when the number of EVs to be charged is greater than the number of charging units (charging posts; e.g. shown in FIG. 3)—computational module 124 may be configured to query the users of each of the loads (e.g. the drivers of each of the EVs) to provide additional information that computational module 124 may take into account in determining the order of charging of the loads and the distribution of the power there between. The information may include urgency of the charging, precise time by which the load must be charged, the extent to which the load must be charged rather than preferably charged (for example, if the load is battery pack of an EV, the extent to which the load must be charged may depend on the destination that the EV is to travel and whether the EV may be charged at that destination, and so on).

According to some embodiments, computational module 124 may be configured to select a respective charging rate for each load. According to some such embodiments, different simultaneously charging loads may be charged at different charging rates. Thus, for example, a first EV, which has to be picked up earlier than a second EV, may be more rapidly charged than the second EV.

According to some embodiments, particularly, embodiments wherein computational module 124 is a computer server or otherwise cloud-based, controller 102 (which is located on-site) may be further configured to allow performing some of computational module 124 functions, for example, when network connectivity is down or poor. More specifically, according to some embodiments, real-time decisions based on safety data—such as the bypassing of a PSD when the temperature thereof and/or pressure therein exceeds a respective threshold, and the disconnecting of a charging load when the temperature thereof and/or pressure therein exceeds a respective threshold—may be assigned, or exclusively assigned to controller 102. According to some embodiments, each of the computational module 124 functions, described in the previous paragraph, may also be performed by controller 102.

According to some embodiments, computational module 124 may be configured to determine (schedule) a timetable (e.g. a daily schedule) for charging depleted and/or non-saturated PSDs. In particular, computational module 124 may be configured to determine the timetable, based on an expected power demand, such as to keep electricity costs low and maintain a ready supply of power (to satisfy the expected power demand). Computational module 124 may be configured to send the timetable to controller 102. Controller 102 may be configured to follow the timetable and accordingly command the switching assembly to enable or circumvent PSDs and/or enable or disable (disconnect) groups of PSDs (such as rows in PSD array 160).

According to some embodiments, the expected power demand may be determined based at least on scheduled charging requests (e.g. for the upcoming day). According to some embodiments, when an unscheduled charging request is received by PMS 100, computational module 124 may be configured to check whether the timetable has to be adjusted—in the sense of having to e.g. bring forward planned charging of some loads, postpone planned charging of other loads, bring forward planned charging of some PSDs, etc.—and, if so, accordingly update the timetable.

According to some embodiments, computational module 124 may be configured to determine the expected power demand by taking into account, or additionally taking into account, usage patterns of PMS 100. According to some such embodiments, the usage patterns may include usage patterns of a plurality of PMS 100, for instance, deployed in a same setting (e.g. in urban residential buildings or in EV charging stations in the countryside). The usage patterns may be detected (identified) by analyzing past usage data of PMS 100, and, optionally, the plurality of PMS 100. The usage patterns may exhibit not only hourly dependence but also daily (i.e. the day of the week), monthly, and/or seasonal dependence. The usage patterns may further exhibit dependence on the weather. Thus, according to some embodiments, the expected power demand, and therefore the scheduled timetable, may depend on the date and/or the weather forecast (Depending on the weather forecast e.g. some people may choose to work from home or alternatively not take the car to work, public works may be postponed, and so on, which may manifest in a decrease or increase in the number charging requests received by PMS 100).

According to some embodiments, computational module 124 may be configured to record (i.e. store in memory module 128) usage data of PMS 100. According to some such embodiments, computational module 124 may be configured to record usage data of a plurality of PMS 100. According to some such embodiments, computational module 124, or at least memory module 128, may be common to (i.e. shared by) each of the plurality of PMS 100.

According to some embodiments, memory module 128 may have stored therein one or more artificial intelligence (AI) tools (for example, machine-learning tools), (AI) algorithms (for example, machine-learning algorithms), and/or artificial-intelligence derivable algorithms (for example, machine-learning derivable algorithms, i.e. algorithms, which may be derived using machine learning tools, e.g. deep learning tools). The machine-learning tools—or more generally the AI tools—may be configured to detect the usage patterns of PMS 100, and optionally, usage patterns of a plurality of PMS 100. Machine-learning algorithms and/or the machine-learning derivable algorithms may be configured to determine (schedule) the timetable and/or determine the expected power demand. According to some embodiments, computational module 124 may further include the machine-learning tools (whether in the form of software stored in memory module 128 or custom processors included in processing module 126), being thereby configured to generate, and improve (as additional usage data is accumulated) the expected power demand.

According to some embodiments, the machine-learning algorithms/machine-learning derivable algorithms may be trained prior to first usage of PMS 100 or may continue to be trained after deployment thereof. According to some embodiments, machine-learning algorithms/machine-learning derivable algorithms may be continuously trained in real-time or near real-time of usage of PMS 100.

According to some embodiments, the algorithms may be configured to obtain one or more usage parameters. According to some embodiments, the one or more usage parameters may include one or more of incurred costs (e.g. at the level of an hour, hourly and/or daily average), power consumption (e.g. at the level of an hour, hourly and/or daily average), charging durations (e.g. charging times and/or average charging times), and/or any combination thereof. Each usage parameter may be provided together with corresponding data including a specific calendar date, as well as weather conditions (or irregular events) on that date.

According to some embodiments, obtaining the one or more usage parameters may include deriving and/or computing the one or more usage parameters from the recorded data associated with a previous usage of PMS 100 or other similar PMSs. According to some embodiments, the machine-learning tools are configured to compute the usage patterns based, at least in part, on the usage parameters—and/or the data provided therewith—as described above.

According to some embodiments, the machine-learning tools may be configured use a training set to train the algorithms to generate an expected power demand and based thereon a timetable. The training set may include the one or more obtained usage parameters and/or the data provided therewith. According to some embodiments, the machine-learning tools may be configured to generate a product algorithm (e.g. a machine-learning derivable algorithm), which may be configured to generate the above-described expected power demand and/or timetable (e.g. on a daily basis) for operating PMS 100, and/or update the timetable in real-time. The machine-learning tools may be configured to generate and/or update the timetable so as to substantially optimize any one of user or operator specified target function (such as average electricity cost and/or average power consumption and/or any functions thereof, e.g. a convex combination), which is to be substantially optimized (e.g. minimized), such that, for example, average electricity, average power consumption, and/or average retirement rate of PSDs from the PSD array is substantially minimized and/or a desired trade-off between is realized on average.

According to some embodiments, PMS 100 may further include a communication unit (not shown) configured to provide network (e.g. internet) connectivity and/or satellite connectivity. In embodiments wherein computational module 124 is cloud-based, the communication unit may communicatively associate controller 102 with computational module 124. When PMS 100 (apart from computational module 124 in embodiments wherein computation module 124 included in PMS 100 but is remotely located) is installed in an urban area (e.g. when PMS 100 is installed in a downtown EV charging station), satellite connectivity may not be necessary and the communication unit may be configured to exclusively provide one or more of ethernet connectivity, Wi-Fi connectivity, and cellular connectivity. When PMS 100 (apart from computational module 124 in embodiments wherein computational module 124 is included in PMS 100 but is remotely located) is installed in an area lacking internet connectivity and cellular connectivity, such as in a remote construction site, the communication unit may be configured to provide satellite connectivity.

According to some embodiments, PMS 100 may include an infrastructure (not shown in FIG. 1) configured to accommodate an array of rechargeable PSDs, such as PSD array 160. The infrastructure may include a plurality of compartments (e.g. chambers and/or holders; not shown), each configured to accommodate one or more PSDs (e.g. from PSD array 160). According to some embodiments, the compartments may be arranged in a rectangular pattern, so that the accommodated PSDs form a rectangular array (e.g. such as the array of FIG. 2A). The infrastructure may further include electrical infrastructure, including contacts for terminals of the PSDs, electrical cables connecting compartments (e.g. successive compartments along a row in the array), and so on. According to some embodiments, the infrastructure may be modular, in the sense that the maximum number of PSDs accommodated thereby may be increased. According to some such embodiments, each of the compartments may be configured for easy deployment and removal and have pre-installed electrical infrastructure and monitoring equipment (i.e. to monitor PSDs). According to some embodiments, each compartment may have installed thereon or therein, or even integrated therein, a switching module from switching modules 108, so that upon accommodation of a PSD within the compartment, the PSD becomes “switch-equipped”.

FIG. 2A presents a circuit diagram illustrating electrical association between PSDs, DC-DC chargers, switching modules, and switches, according to some specific embodiments of the present disclosure. Depicted are an energy storage 250 including a PSD array 260, and a plurality of switching modules 208 (not all of which are numbered). Also depicted are DC-DC chargers 214, switches 212, and pairs of electrical lines 262 (power lines; not all of which are numbered) and 264 (bypass lines; not all of which are numbered). Each pair of electrical lines is associated with one of the PSDs in PSD array 260, respectively. PSD array 260 and DC-DC chargers 214 are specific embodiments of PSD array 160 and DC-DC chargers 114, respectively. Switching modules 208 are specific embodiments of switching modules 108 of the switching assembly of PMS 100. Switches 212 are specific embodiments of switches 112 of the switching assembly of PMS 100.

Also indicated are lines 266 and 268. Line 266 leads from switches 212 via a fourth DC-DC charger 214d (and first main switch 106a; not shown in FIG. 2A) to power source 105. Line 268 may be used to charge rechargeable load(s) (not shown) directly from PSD array 260 without passing through DC-DC chargers 214.

PSDs in PSD array 260 are shown arranged in a rectangular n×m array. Each pair of adjacent PSDs in a row of the array, when both enabled, are serially connected. As a non-limiting example, intended to render the discussion more concrete and facilitate the description, the number of rows n and the number of columns m are each taken to equal 3. That is, the PSDs in PSD array 260 are shown arranged in three rows 252: a first row 252a, a second row 252b, and a third row 252c, which are connected in parallel. Each of rows 252 includes three PSDs, which when enabled are serially connected.

PSD array 260 thus include PSDs 260a1, 260a2, and 260a3 on first row 252a, PSDs 260b1, 260b2, and 260b3 on second row 252b, and PSDs 260c1, 260c2, and 260c3 on third row 252c.

Similarly, in order to render the discussion more concrete and facilitate the description, DC-DC chargers 214 are assumed to include four DC-DC chargers: a first DC-DC charger 214a, a second DC-DC charger 214b, a third DC-DC charger 214c, and fourth DC-DC charger 214d According to some embodiments, switches 212 may include switching components (not shown), which are configured to allow selectively connecting one or more of rows 252 to any one of DC-DC chargers 214.

More specifically, and as depicted in FIG. 2A, each of switching modules 208 may include a pair of switching units: a first switching unit 242 and a second switching unit 244. For example, a switching module 208′ (from switching modules 208) include a first switching unit 242′ (from first switching units 242) and a second switching unit 244′ (from second switching units 244). Each of the PSDs in PSD array 260 is mounted on a respective power line from power lines 262, on which a respective first switching unit, from first switching units 242, is also mounted (such as to be serially connected to the PSD). A respective second switching unit, from second switching units 244, is mounted on a respective bypass line from bypass lines 264 and is connected in parallel to the PSD and the first switching unit. When the PSD is enabled, current may be conducted through the power line, and when the PSD is bypassed (i.e. circumvented), current may be conducted through the bypass line, unless the row, including the PSD, is disabled, in which case no current is conducted through the either of the bypass line and the power line.

Thus, for example, PSD 260b2 (on second row 252b) is mounted on a power line 262′ (from power lines 262), on which first switching unit 242′ is also mounted. Second switching unit 244′ is mounted on a bypass line 264′ (from bypass lines 264), in parallel to PSD 260b2 and first switching unit 242′. When PSD 260b2 is enabled, current is conducted through power line 262′. When PSD 260b2 is bypassed, current is conducted through bypass line 264′, unless second row 252b is disabled, in which case no current is conducted through bypass line 264′ or power line 262′.

Also indicated are a positive terminal Tₚ and a negative terminal Tₙ of PSD 260b2. The rest of the PSDs in PSD array 260 are understood to be identically polarized, i.e. with a positive polarity of each of the PSDs pointing from the left of FIG. 2A to the right thereof. Finally, indicated are a first junction A and a second junction B. Each of power line 262′ (on which PSD 260b2 and first switching unit 242′ are mounted) and bypass line 264′ (on which second switching unit 244′ is mounted) extends between first junction A and second junction B.

According to some embodiments, one or more respective pairs of first switching unit 242 and second switching unit 244 may be a pair of synchronized on/off switches. For example, according to some embodiments, each of first switching unit 242′ and second switching unit 244′ may be an on/off switch. The two on/off switches may be configured to operate synchronously.

According to some embodiments, one or more respective pairs of first switching unit 242 and second switching unit 244 may be a pair of four-state switches. Each of the four-states switches may be switchable between four states S₀, S₁, S₂, and S₃. In the state S₁, current flow through the four-state switch in a first direction is blocked. In the state S₂, current flow through the four-state switch in a second direction (opposite to the first direction) is blocked. In the state S₃, current may be conducted through the four-state switch in either of the two directions. In the state S₀, current cannot be conducted through the four-state switch.

Advantageously, by precluding the joint states (S₁, S₂), (S₁, S₃), (S₃, S₂), and (S₃, S₃), wherein the first entry and the second entry inside each of the brackets denotes states of a first switching unit (e.g. first switching unit 242′) and a second switching unit (e.g. second switching unit 244′) respectively, short-circuits may be prevented. More precisely, short-circuits, which may be induced by discharging of a PSD, mounted on the same line as the first switching unit (e.g. PSD 260b2), onto itself, are prevented. The prevention may be implemented through use of software and/or hardware (e.g. an interlocker).

As a further advantage, the above-described four-state switches allow preventing, or at least minimizing, dips in the current when bypassing a PSD, by transitioning through a joint-state (of the two four-state switches), which allows the current to be divided between the power line and the bypass line, and such that the current flows in the same direction through each of the lines (e.g. from first junction A to second junction B).

A four-state switch, as described above, may be realized, for example, by two enhancement-mode MOSFETs serially connected via their sources or via their drains. Consequently, when both MOSFETs are switched off, the polarities of their respective body diodes are opposite so that current flow through the MOSFETs is blocked (in both directions).

According to some embodiments, one or more respective pairs of first switching unit 242 and second switching unit 244 may constitute an on/off switch and the above-described four-state switch, respectively. For example, according to some embodiments, first switching unit 242′ may be an on/off switch and second switching unit 244′ may be the above-described four-state switch.

FIGS. 2B-2J respectively illustrate example wiring configurations of PSD array 260 allowed by the circuit architecture of FIG. 2A, according to some embodiments. The example wiring configurations are intended to facilitate the description and should be understood to be non-exhaustive. That is, the example wiring configurations constitute a small sample of the total number of possible wiring configurations. Each of the wiring configurations is realized by a respective actuation configuration (of the plurality) of switching modules 208 and switches 212 (as well as main switches 106). Lines extending between elements represent electrical connection therebetween. “Stealth arrowheads” on the lines indicate the direction of current flow. Switching modules 208 and switches 212 (as well as main switches 106) are not shown in FIGS. 2B-2J.

A wiring configuration may be pre-selected by computational module 124. The wiring configuration may specify how PSDs in PSD array 260 are coupled (when enabled). For example, prior to commencing a pre-scheduled charging of a load(s), computational module 124 may select a suitable wiring configuration. In addition, a wiring configuration may be switched to while PMS 100 is in the midst of fulfilling a task (e.g. a charge request, whether pre-scheduled or not). For example, during charging of a load(s), in response to one or more of the PSDs (used to charge the load(s)), nearing depletion, computational module 124 may elect to bypass those PSDs and, optionally, enable other PSDs. Or, for example, during charging of some or all of the PSDs, in response to an urgent unscheduled charge request, computational module 124 may elect to interrupt the charging of one or more of the charging PSDs in order to meet the charge request.

In FIG. 2B the two rightmost PSDs in first row 252a (i.e. PSDs 260a2 and 260a3) are enabled, while the leftmost PSD (i.e. a PSD 260a1) is bypassed. First row 252a is connected to first DC-DC charger 214a, which is used to charge one or more loads (having compatible charging specifications). The loads are not shown.

FIG. 2C differs from FIG. 2B in that the two rightmost PSDs in second row 252b (i.e. PSDs 260b2 and 260b3) are additionally enabled and also connected to first DC-DC charger 214a. PSDs 260b2 and 260b3 are connected in parallel to PSDs 260a2 and 260a3.

It is noted that utilizing a plurality of rows, rather than a single row, to charge a load, allows for the increase of the charging current and therefore a commensurate decrease in the charging time (e.g. when the number of rows is doubled and the same number of PSDs are enabled in each row, potentially substantially halving the charging time when all of the enabled PSDs have been manufactured to the same specification). Alternatively, a plurality of rows, rather than a single row, may be utilized in order to “exert less” each of the utilized PSDs (i.e. reduce the charging current provided by each of the utilized PSDs).

In FIG. 2D the two leftmost PSDs in each of first row 252a (i.e. PSDs 260a1 and 260a2) and second row 252b (i.e. PSDs 260b1 and 260b2) are enabled, while the rightmost PSDs in first row 252a (i.e. PSD 260a3) and second row 252b (i.e. PSD 260b3) are bypassed. Each of first row 252a and second row 252b is connected to second DC-DC charger 214b, which is used to charge one or more loads (not shown). PSDs 260b1 and 260b2 are connected in parallel to PSDs 260a1 and 260a2. Each of the PSDs in third row 252c (i.e. PSDs 260c1, 260c2, and 260c3) is enabled. Third row 252c is connected to third DC-DC charger 214c, which is used to charge one or more other loads (not shown).

FIG. 2E differs from FIG. 2D in that the rightmost PSD in first row 252a (i.e. PSD 260a3) is enabled, rather than bypassed, and the middle PSD in first row 252a (i.e. PSD 260a2) is bypassed, rather than enabled. FIG. 2E further differs from FIG. 2D in that the leftmost PSD in third row 252c (i.e. PSD 260c1) is bypassed, rather than enabled.

Example scenarios—in which the computational module may elect to switch from the wiring configuration of FIG. 2D to that of FIG. 2E—include PSD 260a2 and/or PSD 260c1 approaching depletion before the rest of the enabled PSDs or overheating (while the temperatures of the rest of the enabled PSDs remain within normal limits). According to some embodiments, the activation (i.e. enabling) of PSD 260a3 may compensate for the bypassing of PSD 260a2.

In FIG. 2F all the PSDs in first row 252a, and the two leftmost PSDs in second row 252b, are enabled, while the rightmost PSD in second row 252b is bypassed. Each of first row 252a and second row 252b is connected to first DC-DC charger 214a, which is used to charge one or more loads (not shown). PSDs 260b1 and 260b2 are connected in parallel to PSDs 260a1, 260a2, and 260a3. Each of the PSDs in third row 252c is enabled. Third row 252c is connected, via line 266 (not numbered in FIG. 2F), to fourth DC-DC charger 214d, which, in turn, is connected to power source 105 (directly, when power source 105 provides a DC current, or via an AC-DC converter 115, when power source 105 provides an AC current), which is used to charge the PSDs in third row 252c, as indicated by arrows 270c. (Power source 105 and AC-DC converter 115 are not shown in FIG. 2F.)

In FIG. 2G all the PSDs in first row 252a and third row 252c are enabled. First row 252a and third row 252c are connected, via line 266 (not numbered in FIG. 2G), to fourth DC-DC charger 214d, which, in turn, is connected to power source 105 (not shown in FIG. 2G), which is used to charge the PSDs in first row 252a and third row 252c. The PSDs in third row 252c are connected in parallel to the PSDs in first row 252a.

FIG. 2H differs from FIG. 2G in that the middle PSD in first row 252a (i.e. PSD 260a2) is bypassed, rather than enabled, and is therefore not being charged.

Example scenarios—in which the computational module may elect to switch from the wiring configuration of FIG. 2G to that of FIG. 2H—include PSD 260a2 approaching saturation before the rest of the charging PSDs, a pressure therein exceeding a threshold pressure (while the pressures in the rest of the charging PSDs remain within normal limits), or a voltage across PSD 260a2 crossing an upper threshold or a lower threshold.

In FIG. 2I all the PSDs in second row 252b are enabled. Second row 252b is connected to a second DC-DC charger 214b′, which is a specific embodiment second DC-DC charger 214b and characterized by being bidirectional. The PSDs in second row 252b are being charged by one or more load(s) (not shown), which are connected to second DC-DC charger 214b′, as indicated by arrow 274b.

In FIG. 2J all the PSDs in second row 252b are enabled and are used to directly charge (i.e. without voltage conversion by any of DC-DC chargers 214) one or more rechargeable loads (not shown).

It is to be understood that circuit diagrams other than the circuit diagram of FIG. 2A are covered by the scope of the disclosure. More generally, additional switches/switching modules may be included, which allow, for example, to connect two or more of rows 252 in series, or even redefine the rows (i.e. the groups of serially-connected or connectable PSDs). For instance, according to some embodiments, the rows may be controllably redefined, such that PSDs 260a1, 260b2, and 260c3 are serially-connected or connectable, PSDs 260a2, 260b3, and 260c1 are serially-connected or connectable, and PSDs 260a3, 260b1, and 260c2 are serially-connected or connectable. Most generally, beyond increasing the number of PSDs and/or rows, additional switches/switching modules may be included, which allow each PSD to be controllably directly connected, serially connected, or connected in parallel to any other of the PSDs.

FIG. 3 schematically depicts an EV charging station 300, according to some embodiments. EV charging station 300 has installed thereat a PMS 310, which is a specific embodiment of PMS 100. More specifically, depicted are a power source 305 (here shown in the form of a power pole 307 connected to a power grid), a switch gear 309, a step-down transformer 317, an electricity meter 319, a power conversion-and-distribution (PCD) center 330, a rechargeable energy storage 340, and charging units 325 (not all of which are numbered). PCD center 330 and energy storage 340 (or at least some of the internal components if energy storage 340, such as switching modules) may be included in PMS 310.

Energy storage 340 includes a container 382 housing an array of switched-equipped PSDs (not shown). More specifically, container 382 houses a PSD array, which is a specific embodiment of PSD array 160, and switching modules, which are specific embodiments of switching modules 108. Each of the switching modules may be configured to allow enabling and bypassing a respective PSD in the PSD array, or a respective group of PSDs in the PSD array. According to some embodiments, each of the switching modules may include a first switching unit and a second switching unit, essentially as depicted in FIG. 2A and described in the accompanying description thereof.

According to some embodiments, PCD center 330 includes a container 384 housing at least an AC-DC converter, DC-DC chargers, main switches, and additional switches (not shown), which are specific embodiments of AC-DC converter 115, DC-DC chargers 114, main switches 106, and additional switches 112, respectively. According to some embodiments, not depicted in FIG. 3, the AC-DC converter is not included in PCD center 330.

According to some embodiments, a controller, (not shown) which is a specific embodiment of controller 102 may be housed in container 384 of PCD center 330. Alternatively, according to some embodiments, the controller may be housed in container 382 of energy storage 340. Still, according to some other embodiments, the controller may be distributed between containers 382 and 384. According to some embodiments, not depicted in FIG. 3, EV charging station 300 includes a single container, such that the internal components of energy storage 340 and PCD center 330 are housed in the same container.

According to some embodiments, PMS 310 further includes a computational module, which is a specific embodiment of computational module 124, and which is located on-site, e.g. in PCD center 330. According to some alternative embodiments, wherein the computational module is cloud-based, PMS 310 further includes a communication unit configured to provide network connectivity and/or satellite connectivity, and thereby communicatively associate the controller and the computational module.

Switch gear 309 is shown connected to power pole 307 via above-ground power cables (not numbered). A first (high-voltage) power cable 331 is configured to carry power from switch gear 309 to step-down transformer 317. A second power cable 333 is configured to carry power from step-down transformer 317 to PCD center 330. Electricity meter 319 is mounted on second power cable 333, in between step-down transformer 317 and PCD center 330, and is configured to measure the amount of power consumed by EV charging station 300 from the power grid (i.e. via power pole 307). A first plurality of power cables 341 (as a non-limiting example, totaling six in FIG. 3) leads from energy storage 340 to PCD center 330. A second plurality of power cables 343 (as a non-limiting example, totaling six in FIG. 3) leads from PCD center 330 to charging units 325.

According to some embodiments, and as depicted in FIG. 3, power cables 331 and 333 and first plurality of power cables 341 and second plurality of power cables 343 may run underground.

According to some embodiments, and as depicted in FIG. 3, each of power cables 343 leads to a different charging unit from charging units 325. Thus, for example, a power cable 343a leads to a charging unit 325a, and a power cable 343b leads to a charging unit 325b.

According to some embodiments, each of power cables 341 is connectable to a respective group of PSDs in energy storage 340. As a non-limiting, the PSDs housed in energy storage may be arranged in the form of three-dimensional rectangle (i.e. rectangular cuboid), as a non-limiting example, in three pairs of rows (of serially-connected PSDs) stacked on top of one another. As non-limiting examples, according to some embodiments, each row may include 5 or 10 PSDs, in which case energy storage 340 houses 30 PSDs or 60 PSDs, respectively. Each of power cables 341 may be connectable to a respective row of the PSD array housed in energy storage 340.

According to some embodiments, each power cable in first plurality of power cables 341 may be controllably connectable to a respective power cable in second plurality of power cables 343. That is, in such embodiments, a power cable 341a may be controllably connected to power cable 343a, a power cable 341b may be controllably connected to power cable 343b, and so on.

According to some embodiments, PCD center 330 may be configured such that at least some of power cables 341 are each selectively connectable to two or more of power cables 343. For example, power cable 341a may be selectively connected to power cable 343a or power cable 343b. According to some such embodiments, each of power cables 341 may be selectively connected to each of power cables 343. That is, in such embodiments, power cable 341a may be selectively connected to any one of power cables 343, power cable 341b may be selectively connected to any one of power cables 343, and so on.

When an EV, such as an electric car 361, is to be charged—i.e. when car 361 is first connected to charging unit 325a—a communication protocol is initiated between the car computer and the controller of PMS 310, in which charging requirements (i.e. charging parameters) are specified. The charging parameters may include one or more of a charging voltage, charging current, and/or charging power of the battery pack(s) of the EV. Additional charging parameters, such as minimum and/or maximum charging voltages, maximum charging current, and/or maximum charging power. Driver-specified parameters (or passenger-specified if the EV is fully automated), such as to what extent the driver would like the EV battery pack to be charged (e.g. to 50% capacity or to 80% capacity), the sum to be paid (so that the EV battery pack is to be charged to an extent commensurate to the sum), and/or whether the charging is to proceed immediately, and, if not, by what time should the charging be completed (this last point may be particularly relevant when the EV is parked at a reserved parking therefor).

The charging parameters are sent from the charging unit to the controller in PCD center 330, which may relay the charging parameters to the computational module. The computational module may then decide how to charge the EV, essentially, as described above in the description of FIGS. 1-2J.

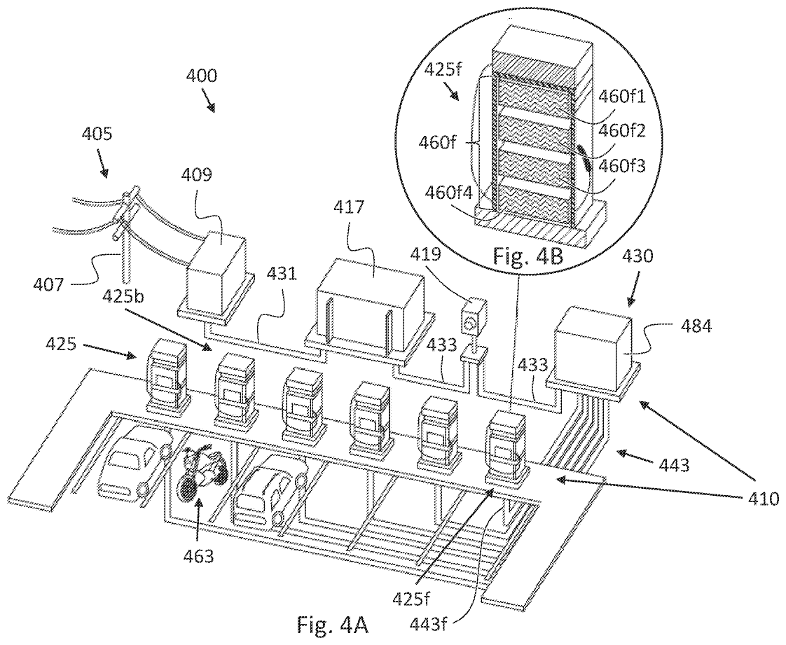

FIG. 4 schematically depicts an EV charging station 400, according to some embodiments. EV charging station 400 has installed thereat a PMS 410, which is a specific embodiment of PMS 100. More specifically, depicted are a power source 405 (here shown in the form of a power pole 407 connected to a power grid), a switch gear 409, a step-down transformer 417, an electricity meter 419, a PCD center 430, and charging units 425 (not all of which are numbered). PCD center 430 and charging units 425 (or at least some of the internal components thereof) may be included in PMS 410.

Unlike EV charging station 300, EV charging station does not include a unique (single) energy storage. Instead, the energy storage is divided between charging units 425. More specifically—and as depicted in FIG. 4B, which presents a schematic (and enlarged) cutaway view of a charging unit 425f, according to some embodiments—each of charging units 425 includes plurality of PSDs. Referring to FIG. 4B, charging unit 425f is shown with a front surface thereof removed. Charging unit 425f may include a PSD stack 460f, which, as a non-limiting example, includes four PSDs 460f1, 460f2, 4606, and 460f4 stacked one on top of the other. Each of charging units 425 may further include a DC-DC charger (not shown), which is a specific embodiment of one of DC-DC chargers 114.

According to some embodiments, different charging units, from charging units 425, may include different PSD stacks and/or different DC-DC chargers. Thus, different charging units, from charging units 425, may be configured to service different types of EVs. As a non-limiting examples, one or more of charging units 425 may be configured to service smaller EVs, such as electric motorcycles, while one or other of charging units 425, may be configured to service electric passenger cars.

According to some embodiments, PCD center 430 includes a container 484 housing at least an AC-DC converter and main switches (not shown), which are specific embodiments of AC-DC converter 115 and main switches 106, respectively. According to some embodiments, not depicted in FIG. 4, the AC-DC converter is not included in PCD center 430.

According to some embodiments, a controller (not shown), which is a specific embodiment of controller 102 may be housed in container 484 of PCD center 430. Alternatively, according to some embodiments, the controller may be distributed between PCD center 430 and each of charging units 425. That is, PCD center 430 may include a main controller while each of charging units 425 may include a respective secondary controller.

According to some embodiments, PMS 410 further includes a computational module, which is a specific embodiment of computational module 124, and which is located on-site, e.g. in PCD center 430. According to some alternative embodiments, wherein the computational module is cloud-based, PMS 410 further includes a communication unit configured to provide network connectivity and/or satellite connectivity, and thereby communicatively associate the controller and the computational module.

Switch gear 409 is shown connected to power pole 407 via above-ground power cables (not numbered). A first (high-voltage) power cable 431 is configured to carry power from switch gear 409 to step-down transformer 417. A second power cable 433 is configured to carry power from step-down transformer 417 to PCD center 430. Electricity meter 419 is mounted on second power cable 433, in between step-down transformer 417 and PCD center 430, and is configured to measure the amount of power consumed by EV charging station 400 from the power grid (i.e. via power pole 407). A plurality of power cables 443 (as a non-limiting example, six cables in FIG. 4) leads from PCD center 430 to charging units 425.

According to some embodiments, and as depicted in FIG. 4, power cables 431 and 433 and plurality of power cables 443 may run underground.

According to some embodiments, and as depicted in FIG. 4, each of power cables 443 leads to a different charging unit from charging units 425. Thus, for example, a power cable 443f leads to a charging unit 425f.

When an EV, such an electric motorcycle 463, is to be charged—i.e. when motorcycle 463 is first connected to a charging unit 425b—a communication protocol is initiated between the car computer and the controller (or main controller) of PMS 410 in which charging parameters are specified, essentially as described above in the description of FIG. 3.

The charging parameters are sent from the charging unit to the controller in PCD center 430, which may relay the charging parameters to the computational module. The computational module may then decide how to charge the EV, essentially, as described above in the description of FIGS. 1-2J.

According to some embodiments, PMS 410 may be configured to allow transferring power (energy) from one of charging units 425 to another of charging units 425, thereby allowing using at least two different PSD stacks (from two or more different charging units), each configured to charge a load. In such embodiments, charging units 425 may effectively constitute a single energy storage, which is reconfigurable. As a non-limiting example, two or more charging units, each of which is configured to charge electric passenger cars and/or electric motorcycles, may be utilized jointly to charge a rechargeable load requiring high charging voltage, such as an electric bus or an electric truck.

According to some such embodiments, power may be transferred from each of charging units 425 to any other of charging units 425. According to some embodiments, the transfer may be carried out using cables 433. According to some embodiments, EV charging station 400 may include additional cables (not show) directly coupling adjacent charging units 425, and which may allow transfer of power between adjacent charging units 425.

Methods

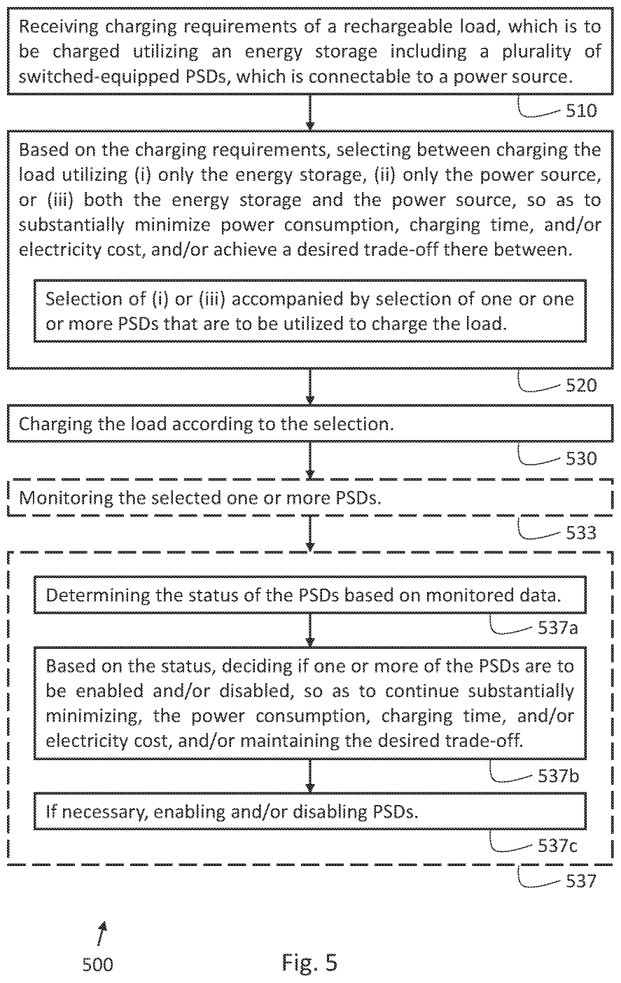

According to an aspect of some embodiments, there is provided a computer-implemented method for managing responses of an energy storage to charge requests of one or more rechargeable loads. The energy storage includes a plurality of rechargeable power-storage devices (PSDs) and is connectable to a power source. FIG. 5 presents a flowchart of such a method, a method 500, according to some embodiments. The skilled person will readily appreciate that method 500 may be implemented using PMS 100. In particular, computational operations and decisions, included in method 500, may be implemented using computational module 124 and/or controller 102 of PMS 100. Further, it is to be understood that the description of computational module 124, and optionally controller 102, is also relevant for method 500 in the sense that some operations of method 500—which are implementable by computational module 124 and/or controller 102—may be described in more detail in the Systems subsection.

According to some embodiments, method 500 includes:
An operation 510, wherein charging requirements of a rechargeable load (e.g. rechargeable load 111), which is to be charged, are received.
An operation 520, wherein, based on the charging requirements, it is selected whether to charge the load utilizing (i) only the energy storage (e.g. energy storage 150), (ii) only the power source (e.g. power source 105), or (iii) both the energy storage and the power source, so as to substantially minimize power consumption, charging time, and/or electricity cost, and/or achieve a desired trade-off there between. If (i) or (iii) is selected, the selection may additionally include selecting which of the plurality of PSDs (e.g. PSD array 160) is to be utilized to charge the load.
An operation 530, wherein the load is charged as prescribed by the selection.

According to some embodiments, the selected PSDs include two or more serially connected, or connectable, PSDs (e.g. the first row and the second row in FIG. 2B).

According to some embodiments, the plurality of PSDs may be arranged in a two-dimensional or a three-dimensional array, for example, a two-dimensional rectangular array (e.g. PSD array 260) or a three-dimensional rectangular array. According to some such embodiments, the selected PSDs may constitute one or more rows in the array.

According to some embodiments, PSDs in a row may be serially connected or connectable.

According to some embodiments, in operation 510, the charging requirements may specify values of one or more of a charging voltage, a charging current, and a charging power of the load.

According to some embodiments, in operation 510, the charging requirements may further specify safety data of the load, such as a maximum temperature, a maximum charging current, and/or a maximum charging power allowed for the load. According to some embodiments, in addition, to the charging requirements, values specifying the SoC and (full) charge capacity of the load may also be received.

According to some embodiments, in operation 510, in addition to the charging requirements, values specified by the user (e.g. the driver) may also be received. These received (user-specified) values may include, for example, the degree to which the user would like to charge the load (e.g. to half capacity, to full capacity), or the sum (amount of money) at which the user would like to charge the load.

According to some embodiments, operation 520 further includes deciding, which PSDs in each group (e.g. PSDs 260a2 and 260a3 in the first row and PSDs 260b2 and 260b3 in the second row in FIG. 2B) are to be employed in charging the load, essentially as described above in the Systems subsection in the description of computational module 124 and controller 102.

According to some embodiments, in operation 530, different groups of selected PSDs may be successively utilized to charge the load.

According to some embodiments, method 500 further includes monitoring (e.g. using monitoring equipment 118) one or more electrical parameters of discharging PSDs (as specified above in the Systems subsection), and—contingent on a monitored value of an electrical parameter of a discharging PSD indicating that the discharging PSD is depleted or sufficiently near depleted—disabling the discharging PSD, which may then or later be recharged. When the discharging PSD is connected in series to one or more other discharging PSDs, the discharging PSD may be disabled by bypassing (i.e. circumvention) thereof.

According to some embodiments, method 500 further includes monitoring (e.g. using monitoring equipment 118) one or more electrical parameters of charging PSDs, and contingent on a monitored value of an electrical parameter of a charging PSD indicating that the charging PSD is saturated or sufficiently near saturated—disabling the charging PSD. When the charging PSD is connected in series to one or more other charging PSDs, the charging PSD may be disabled by bypassing thereof.

According to some embodiments, method 500 further includes monitoring (e.g. using monitoring equipment 118) charging and/or discharging PSDs to obtain one or more safety-related parameters (as specified above in the Systems subsection) of the charging and/or discharging PSDs, and—contingent on a monitored value of a safety-related parameter of a PSD crossing a respective threshold—disabling (e.g. bypassing) the PSD.

According to some embodiments, method 500 further includes an optional operation 533 and an optional operation 537. In operation 533, (some or all of the) selected PSDs are monitored (e.g. using monitoring equipment 118). Operation 537 includes sub-operations of:
A sub-operation 537a, wherein based on real-time, or near real-time, monitored data of selected PSDs, the status of the monitored PSDs is determined.
A sub-operation 537b, wherein, based on the status, it is decided if one or more of the monitored PSDs are to be enabled and/or disabled (e.g. bypassed), so as to continue substantially minimizing, the power consumption, charging time, and/or electricity cost, and/or maintaining the desired trade-off there between.
A sub-operation 537c, wherein, if necessary, PSDs are enabled and/or disabled (e.g. bypassed) according to the decision made in sub-operation 537b.

According to some embodiments, method 500 further includes, based on real-time, or near real-time, monitoring data of PSDs from the selected one or more groups:
Determining status of the monitored PSDs.
Based on the status, deciding if the plurality of PSDs is to be rewired, such as to continue substantially minimizing the power consumption, charging time, and/or electricity cost, and/or maintain the desired trade-off there between, essentially as described above in the Systems subsection with respect to PMS 100.
If necessary, rewiring the plurality of PSDs as decided.

According to some embodiments, method 500 further includes monitoring (e.g. using monitoring equipment 118) one or more electrical parameters of a load (as specified above in the Systems subsection) that is being charged by the energy storage, and contingent a on monitored value of an electrical parameter of the charging load indicating that the charging load is saturated or sufficiently near saturated—disconnecting the load.

According to some embodiments, method 500 further includes monitoring (e.g. using monitoring equipment 118) a charging load (charged by the energy storage) to obtain one or more safety-related parameters thereof (as specified above in the Systems subsection), and—contingent on a monitored value of one of a safety-related parameter of the charging load crossing a respective threshold—disconnecting the charging load.

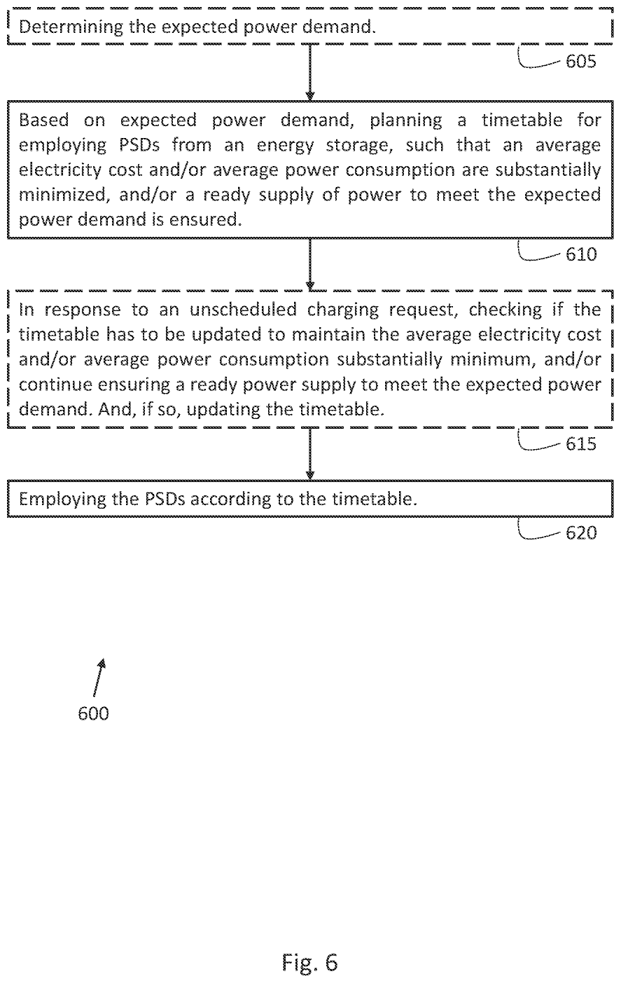

According to an aspect of some embodiments, there is provided a computer-implemented method for managing an energy storage. The energy storage (i) is configured for servicing rechargeable loads, (ii) includes a plurality of rechargeable power-storage devices (PSDs), and (iii) is connectable to a power source. FIG. 6 presents a flowchart of such a method, a method 600, according to some embodiments. The skilled person will readily appreciate that method 600 may be implemented using PMS 100. In particular, computational operations and decisions, included in method 600, may be implemented using computational module 124 and/or controller 102 of PMS 100. Further, it is to be understood that the description of computational module 124 is also relevant for method 600 in the sense that some operations of method 600—which are implementable by computational module 124 and/or controller 102—may be described in more detail in the Systems subsection.

According to some embodiments, method 600 includes:
An operation 610, wherein a timetable for employing PSDs, from the plurality of PSDs, is planned (i.e. determined). The planning may take into account an expected power demand from the energy storage, such that on average at least one of electricity cost and a power consumption is substantially minimized and/or a desired trade-off therebetween is achieved, and/or a ready supply of power to meet the expected power demand is ensured.
An optional operation 615, wherein, in response to an unscheduled charging request, it is checked whether the timetable has to be updated in order to maintain the at least one of the electricity cost and/or the power consumption substantially minimized and/or the desired trade-off therebetween, and/or continue ensuring a ready supply of power to meet the expected power demand, and, if so, updating the timetable.
An operation 620 of employing the plurality of PSDs according to the timetable.

According to some embodiments, operation 610 may be implemented as taught above in the Systems subsection in the description of computational module 124.

According to some embodiments, in operation 610 long-term considerations may further be taken into account, such as substantially minimizing retirement rate of the PSDs from the plurality of PSDs.

According to some embodiments, method 600 further includes an initial operation 605, wherein the expected power demand is determined. According to some embodiments, the expected power demand may be determined based at least on scheduled charging requests.

According to some embodiments, the expected power demand is determined taking into account, or additionally taking into account, usage patterns of the energy storage or a plurality of the energy storage. According to some embodiments, method 600 further includes identifying the usage patterns by analyzing past usage data of the energy storage or a plurality of the energy storage.

According to some embodiments, machine-learning tools are employed to identify the usage patterns. According to some embodiments, the expected power demand is determined utilizing machine learning tools.

In particular, it is noted that operation 605 may be implemented as taught above in the Systems subsection in the description of computational module 124.

Referring again to method 500, according to some embodiments, method 500 may incorporate method 600. More specifically, in operation 520, the selection of the PSDs, which are to be employed to charge the load, may be performed taking into account the timetable and/or the expected power demand of method 600.

As used herein, the term “PSD array” is used to refer to an array of PSDs, that is a plurality of PSDs. More specifically, according to some embodiments, the term “PSD array” may be used to refer to a plurality of PSDs that includes groups of interconnected or interconnectable PSDs. Thus, as non-limiting examples, a group may include a plurality of serially-connected PSDs or a plurality of PSDs connected in parallel. In addition, according to some embodiments, groups may be connected to one another, e.g. in parallel and/or in series. Most generally, the term “PSD array” may be used to refer to an array of PSDs whose interconnections may be controllably modified, such as to allow rewiring the array (that is, not only enabling and bypassing PSDs in the PSD array but also changing the coupling between PSDs). As a non-limiting example, a PSD array may be switched between a first wiring configuration and a second wiring configuration, such that in the first configuration, some PSDs, which when enabled, are connected in series, in the second configuration (the same PSDs, when enabled) are connected in parallel.

As used herein, the nouns “energy” and “power” may be used interchangeably. Thus, for example, the terms “energy storage” and “power storage” are interchangeable. Similarly, the terms “energy supply” and “power supply” are interchangeable.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications, and variations that are apparent to those skilled in the art may exist. Accordingly, the disclosure embraces all such alternatives, modifications, and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

1-67. (canceled)

68. A system for managing a rechargeable energy storage, the system comprising a controller, a switching assembly commanded by the controller, and a DC-DC charger associated or associable via the switching assembly with an array comprising a plurality power storage devices (PSDs);
wherein the system is configured to be connected to a power source, and to be connected to rechargeable loads of different charging voltages at least via the DC-DC charger;
wherein the switching assembly is configured to individually enable and circumvent at least some of the PSDs in the array;
wherein the controller is communicatively associated with a computational module configured to:
receive charging requirements of a rechargeable load;
based on the charging requirements, select whether to charge the load (i) exclusively via one or more PSDs in the array, (ii) exclusively via the power source, or (iii) jointly via one or more PSDs in the array and the power source, the selection being configured so as to substantially minimize one or more of a power consumption, charging time, and electricity cost, and/or achieve a desired trade-off there between; and
send the selection to the controller; and
wherein the controller is configured to, on receipt of the selection, if required, command the switching assembly to enable charging of the load by the selected PSDs.

69. The system of claim 68, wherein the computational module comprises a processing module and a memory module having stored therein software, executable by the processing module, which causes the processing module to make the selection, based at least on the charging requirements.

70. The system of claim 69, further comprising the memory module.

71. The system of claim 69, further comprising the computational module.

72. The system of claim 68, wherein the plurality of PSDs comprises at least five connected or connectable PSDs.

73. The system of claim 68, wherein the charging requirements comprise values of one or more of a charging voltage, a charging current, and a charging power of the load.

74. The system of claim 68, wherein the computational module is configured to make the selection such that power supplied to the load would remain substantially continuous under disabling of:
any PSD, included in the selection, which is configured to allow independent circumvention thereof; and
any group of PSDs, included in the selection, which consists of selected PSDs that cannot be independently circumvented, but such that the group is configured to allow independent circumvention and/or disconnection thereof.

75. The system of claim 68, wherein at least some of the selected PSDs are serially connected or connectable to one another.

76. The system of claim 68, wherein the switching assembly is configured to allow, during charging of a load, increasing a number of PSDs used to charge a load, as well as replacing one or more of the selected PSDs by one or more other PSDs.

77. The system of claim 68, further comprising monitoring equipment configured to monitor the PSDs in the array, or at least charging or discharging PSDs in the array, and send monitored values thereof to the controller and/or the computational module.

78. The system of claim 77, wherein the monitoring equipment comprises one or more of an ammeter, a voltmeter, an ohmmeter, a capacitance meter, a thermometer, and a pressure meter.

79. The system of claim 77, wherein the monitoring equipment is further configured to monitor each charging load and send monitored values thereof to the controller and/or the computational module.

80. The system of claim 68, wherein, during discharging of a PSD in the array, the computational module and/or the controller are configured to, when the discharging PSD is depleted or sufficiently near depleted, over-heated, and/or over-pressurized, instruct the switching assembly to circumvent the PSD; and
wherein, during charging of a PSD in the array, the computational module and/or the controller are configured to, when the charging PSD is saturated or sufficiently near saturated, over-heated, and/or over-pressurized, instruct the switching assembly to circumvent the PSD.

81. The system of claim 68, wherein, during charging of a load, the computational module and/or the controller are configured to, when the load is saturated or sufficiently near saturated, instruct the switching assembly to disconnect the load.

82. The system of claim 77, further comprising the monitoring equipment, wherein the computational module and/or the controller are configured to, based on real-time data from the monitoring equipment: (i) determine status of PSDs in the array, (ii) based on the status, decide if one or more of the PSDs in the array are to be enabled and/or circumvented, such as to continue substantially minimizing the one or more of the power consumption, charging time, electricity cost, and/or achieve the desired trade-off there between, and, if so, (iii) command the switching assembly to enable and/or circumvent said one or more PSDs.

83. The system of claim 68, wherein the switching assembly is configured to allow rewiring the array, so as to redefine groups of serially connected PSDs in the array.

84. The system of claim 83, further comprising the monitoring equipment, wherein the computational module and/or the controller are configured to, based on real-time data from the monitoring equipment: (i) determine status of PSDs in the array, (ii) based on the status, decide if the array is to be rewired, such as to continue substantially minimizing the one or more of the power consumption, charging time, electricity cost, and/or achieve the desired trade-off there between, and, if so, (iii) command the switching assembly to rewire the array as decided.

85. The system of any claim 68, wherein the computational module is further configured to: (i) determine a timetable for utilizing PSDs in the array, taking into account an expected power demand, so as to keep electricity costs low and ensure a ready supply of power to meet the expected power demand, and (ii) send the timetable to the controller; and
wherein the controller is configured to command the switching assembly to enable and/or circumvent PSDs in the array in accordance with the timetable

86. A computer-implemented method for managing responses of an energy storage to charge requests of one or more rechargeable loads, the energy storage comprising a plurality of rechargeable power-storage devices (PSDs), and is connectable to a power source, the method comprising:
receiving charging requirements of a rechargeable load that is to be charged;
based at least on the charging requirements, selecting whether to charge the load (i) exclusively via one or more PSDs from the plurality of PSDs, (ii) exclusively via the power source, or (iii) jointly via one or more PSDs, from the plurality of PSDs, and the power source, so as to substantially minimize one or more of a power consumption, charging time, and electricity cost, and/or achieve a desired trade-off there between; and
charging the load according to the selection.

87. A computer-implemented method for managing an energy storage for servicing one or more rechargeable loads, the energy storage comprising a plurality of rechargeable power-storage devices (PSDs), and is connectable to a power source, the method comprising:
planning a timetable for employing PSDs from the plurality of PSDs, taking into account an expected power demand, so as to substantially minimize an average electricity cost and/or average power consumption, and/or ensure a ready supply of power to meet the expected power demand; and
utilizing the PSDs from the plurality of PSDs according to the timetable.
